(19) United States
(12) Patent Application Publication
(10) Pub. No.: US 2024/0399969 A1
(43) Pub. Date: Dec. 5, 2024

(54) STORAGE FOR A VEHICLE

(71) Applicant: Polaris Industries Inc., Medina, MN (US)

(72) Inventors: Alexander T. Ebertowski, St. Paul, MN (US); Jason A. Eichenberger, Roseau, MN (US); Scott D. Taylor, Wyoming, MN (US); Boris Rubanovich, Oak Grove, MN (US); Jeffrey J. Schwichtenberg, Wyoming, MN (US); Sivakumar Thangavel, Bengaluru (IN)

(73) Assignee: Polaris Industries Inc., Medina, MN (US)

(21) Appl. No.: 18/677,984

(22) Filed: May 30, 2024

Related U.S. Application Data
(60) Provisional application No. 63/470,478, filed on Jun. 2, 2023.

(51) Int. Cl. B60R 9/06; B60R 3/00; B60R 7/02; B60R 7/04

(52) U.S. Cl. CPC B60R 9/06; B60R 3/007; B60R 7/02; B60R 7/04; B60R 7/043

(57) ABSTRACT

Aspects of the present disclosure relate to storage for a vehicle. For instance, example portable work surface assemblies and various cargo-carrying assemblies are provided, each of which may be used in conjunction with a variety of vehicle types. Additionally, a storage rack and nesting cargo-carrying panels are disclosed, thereby further improving the utility of the disclosed cargo-carrying assemblies. Further, various false floor assemblies are provided that improve comfort for shorter riders while also offering additional storage. Example aspects relating to an under-seat storage tray and an in-seat storage assembly are disclosed that further improve usability and offer additional storage options. Finally, aspects relating to a dual-access storage compartment and a two-part lid for a storage compartment are described.

### CROSS REFERENCE TO RELATED APPLICATION

The present application claims the benefit of U.S. Provisional Patent Application Ser. No. 63/470,478, filed Jun. 2, 2024, the disclosure of which is incorporated herein by reference in its entirety.

### BACKGROUND

An individual may not only wish to store a variety of objects within a vehicle but may also wish to use the vehicle as a work surface (e.g., with which to manipulate or otherwise use such stored objects). However, to the extent storage is provided by the vehicle, organization using the provided storage may be challenging and may thus result in frustration, decreased utilization of provided storage, and an inability to find stored objects. Further, the limited nature of such storage may restrict usability of the vehicle as a work surface which may thus limit the utility of the vehicle to an individual.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to a portable work surface assembly for a vehicle. The portable work surface assembly comprises: a plurality of panels that cooperate, in a closed configuration of the portable work surface assembly, to form a storage cavity, the plurality of panels comprising: a bottom panel; a plurality of side panels coupled to the bottom panel; a front panel coupled to the bottom panel; a top panel hingedly coupled to the front panel; and a rear panel coupled to the bottom panel, wherein the top panel is removably coupled to the rear panel; a plurality of support members coupled to the top panel of the portable work surface assembly, wherein the plurality of support members are configured to, in an open configuration of the portable work surface assembly, support the top panel; and a mount coupled to the at least one panel of the plurality of panels, wherein the mount is configured to removably attach the portable work surface assembly to the vehicle.

In another example, a cargo-carrying assembly for a vehicle is provided. The cargo-carrying assembly comprises: a cargo-carrying surface supported by a frame of the cargo-carrying assembly; a plurality of panels that are each removably coupled to the frame by a respective hinge of a plurality of hinges, the plurality of panels comprising a first side panel, a second side panel, and a tailgate panel, wherein: each panel of the plurality of panels includes an opening configured to receive a hinge of the plurality of hinges; each hinge of the plurality of hinges is sized and shaped to permit rotation of a panel around an axis and to permit removal of the panel at a predefined angle; in a vertical orientation, the tailgate panel is configured to be removably coupled to the first side panel in a vertical orientation and the second a vertical orientation; and in horizontal orientations, the tailgate panel, the first side panel, and the second side panel cooperate with the cargo-carrying surface to form a work surface.

In a further example, a false floor assembly for a vehicle is provided. The false floor assembly comprises: an enclosure forming a storage compartment, wherein a height of the enclosure corresponds to a height of a central tunnel of the vehicle and a bottom of the enclosure includes a plurality of openings that are each configured to receive a fastener therethrough, thereby securing the enclosure to the vehicle; a storage compartment lid disposed in a top surface of the enclosure, wherein the storage compartment lid includes a lockable latch and is rotatably coupled to the enclosure by a hinge; and a step assembly mechanically coupled to the enclosure, wherein the step assembly, when actuated, extends a step to support a passenger of the vehicle.

In yet another example, an under-seat storage assembly for a vehicle is provided. The under-seat storage assembly comprises: a lid configured to be coupled to an underside of a seat of the vehicle using a fastener pattern corresponding to one or more pre-existing openings in the underside of the seat, the lid comprising a plurality of tracks; a drawer configured to be supported by the plurality of tracks of the lid, wherein the tracks comprise a first detent that corresponds to an open position of the drawer and a second detent that corresponds to a closed position of the drawer.

In a further example, a vehicle is provided. The vehicle comprises: a plurality of ground-engaging members; a frame supported by the plurality of ground-engaging members; and a rear storage compartment supported by the frame, the rear storage compartment having: a first access point at a top of the rear storage compartment; and a second access point at a rear of the rear storage compartment.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1A is a perspective view of an example vehicle.

FIG. 1B illustrates a left side view of the example vehicle of FIG. 1A.

FIG. 1C illustrates a top view of the example vehicle of FIG. 1A.

FIG. 1D illustrates a front view of the example vehicle of FIG. 1A.

FIG. 1E illustrates a back view of the example vehicle of FIG. 1A.

FIG. 1F illustrates a side view of a portion of the vehicle of FIG. 1A, illustrating the placement of a front differential, a power source, a transmission, and a rear differential.

FIG. 2A illustrates a front perspective view of an example portable work surface assembly in a closed configuration for attachment to a vehicle according to aspects described herein.

FIG. 2B illustrates a rear perspective view of the example portable work surface assembly of FIG. 2A in a closed configuration.

FIG. 2C illustrates a front perspective view of the example portable work surface assembly of FIG. 2A in an open configuration.

FIGS. 2D-2F illustrate the example portable work surface assembly of FIG. 2A as it transitions from a closed configuration to an open configuration.

FIG. 3A illustrates a front perspective view of another example portable work surface assembly in a closed configuration for attachment to a vehicle according to aspects described herein.

FIG. 3B illustrates a front perspective view of the example portable work surface assembly of FIG. 3A in a partially open configuration.

FIG. 3C illustrates another front perspective view of the example portable work surface assembly of FIG. 3A in a partially open configuration, where the support members have been extended.

FIG. 3D illustrates the example portable work surface assembly of FIG. 3A in an open configuration.

FIG. 4A illustrates a perspective view of an example fold-flat cargo-carrying assembly for a vehicle according to aspects described herein.

FIG. 4B illustrates a perspective view of the example fold-flat cargo-carrying assembly of FIG. 4A, where supports have been removed for one of the panels.

FIG. 4C illustrates a perspective view of the example fold-flat cargo-carrying assembly of FIG. 4A, where a panel has been rotated into a horizontal position.

FIG. 4D illustrates a perspective view of the example fold-flat cargo-carrying assembly of FIG. 4A, where two panels have been rotated into a horizontal position and one panel has been rotated into a removal position.

FIG. 4E illustrates a perspective view of the example fold-flat cargo-carrying assembly of FIG. 4A, where the panel of FIG. 4D has been removed.

FIG. 4F illustrates a perspective view of the example fold-flat cargo-carrying assembly of FIG. 4A, where all panels and supports have been removed.

FIGS. 4G and 4H illustrate detail views of an example support for the fold-flat cargo-carrying assembly of FIG. 4A.

FIG. 4I illustrates a detail view of an example hinge for the fold-flat cargo-carrying assembly of FIG. 4A.

FIG. 4J illustrates a cross-sectional view of an example hinge disposed within a panel of the fold-flat cargo-carrying assembly of FIG. 4A.

FIG. 5A illustrates a perspective view of an example storage rack for a vehicle according to aspects described herein.

FIG. 5B illustrates the example storage rack of FIG. 5A, where the storage rack has been removably coupled to the vehicle.

FIG. 5C illustrates the example storage rack of FIG. 5A, where the storage rack has been filled with panels (e.g., of a cargo-carrying assembly according to aspects described herein).

FIGS. 6A-6C illustrate perspective views of an example nesting panel assembly.

FIG. 6D illustrates a perspective view of a vehicle that includes the example nesting panel assembly of FIGS. 6A-6C.

FIG. 6E illustrates a cross-sectional view of the example nesting panel assembly of FIGS. 6A-6C.

FIG. 6F illustrates a top down view of the example nesting panel assembly of FIGS. 6A-6C.

FIG. 7A illustrates a perspective view of another example fold-flat cargo-carrying assembly for a vehicle according to aspects described herein.

FIG. 7B illustrates a top down view of the example fold-flat cargo-carrying assembly of FIG. 7A.

FIGS. 7C and 7D illustrate perspective views of an example where a panel of the fold-flat cargo-carrying assembly of FIG. 7A is removed according to aspects described herein.

FIGS. 7E and 7F illustrate detail views of a hinge assembly of the fold-flat cargo-carrying assembly of FIG. 7A.

FIG. 7G illustrates a perspective view of a further example fold-flat cargo-carrying assembly for a vehicle according to aspects described herein.

FIGS. 7H-7J illustrate perspective views of various configurations for a panel of the example cargo-carrying assembly of FIG. 7G.

FIG. 8A illustrates a perspective view of an example false floor assembly for a vehicle according to aspects described herein.

FIG. 8B illustrates the example false floor assembly of FIG. 8A where a step of the false floor assembly has been extended for use by an individual.

FIGS. 8C and 8D illustrate detail views of a step subassembly for the example false floor assembly of FIG. 8A.

FIG. 8E illustrates a perspective view of the example false floor assembly of FIG. 8A installed in an example vehicle.

FIG. 8F illustrates a top down view of the example false floor assembly of FIG. 8A installed in an example vehicle.

FIG. 8G illustrates a perspective view of another example false floor assembly according to aspects described herein.

FIG. 8H illustrates a detail view of a locking latch of the false floor assembly of FIG. 8G.

FIG. 8I illustrates a perspective view of the false floor assembly of FIG. 8G in an open configuration.

FIG. 8J illustrates a further example false floor assembly according to aspects described herein.

FIG. 8K illustrates yet another example false floor assembly according to aspects described herein.

FIG. 9A illustrates a perspective view of an example under-seat storage tray installed in a vehicle according to aspects described herein.

FIG. 9B illustrates the example under-seat storage tray of FIG. 9A in an open configuration.

FIG. 9C illustrates another perspective view of the example under-seat storage tray of FIG. 9A.

FIG. 10 illustrates a schematic view of an example storage system for retaining objects within a storage compartment of a vehicle according to aspects described herein.

FIG. 11 illustrates an example in-seat storage assembly according to aspects described herein.

FIG. 12A illustrates a perspective view of an example vehicle having a storage compartment that is accessible from a top access point and a rear access point according to aspects described herein.

FIG. 12B illustrates a rear view of the example vehicle of FIG. 12A.

FIG. 12C illustrates a detail rear perspective view of the example vehicle of FIG. 12A.

FIG. 13 illustrates a perspective view of an example two-part lid for a storage compartment of a vehicle according to aspects described herein.

### DETAILED DESCRIPTION

Various embodiments of the present disclosure will be described in detail with reference to the drawings, wherein like reference numerals represent like parts and assemblies throughout the several views. Reference to various embodiments does not limit the scope of the disclosure, which is limited only by the scope of the claims attached hereto. Additionally, any examples set forth in this specification are not intended to be limiting and merely set forth some of the many possible embodiments for the claimed invention.

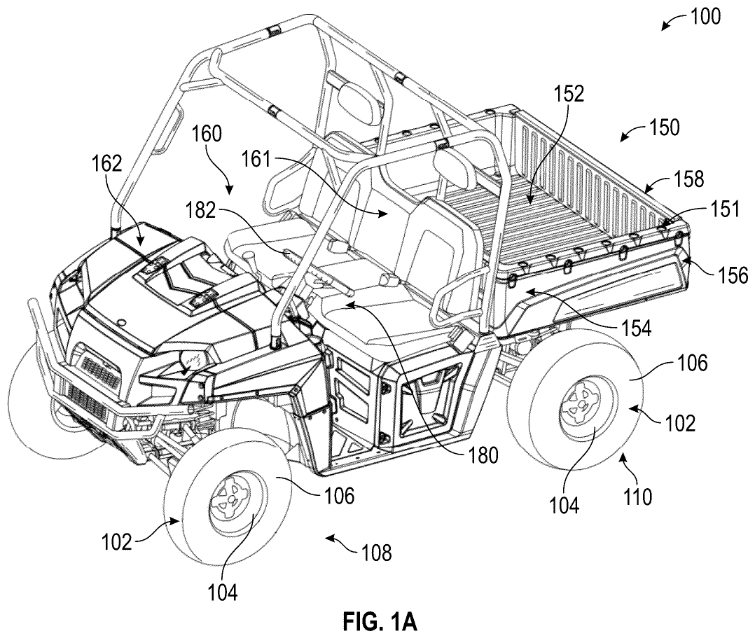

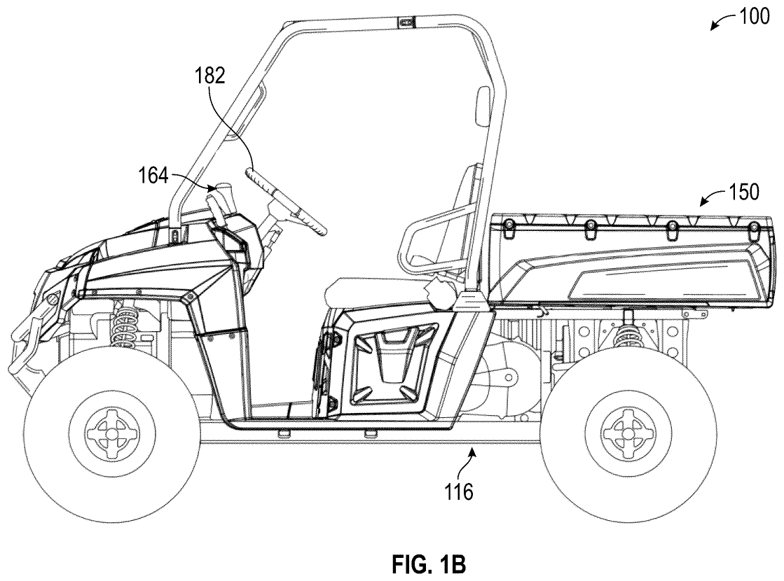

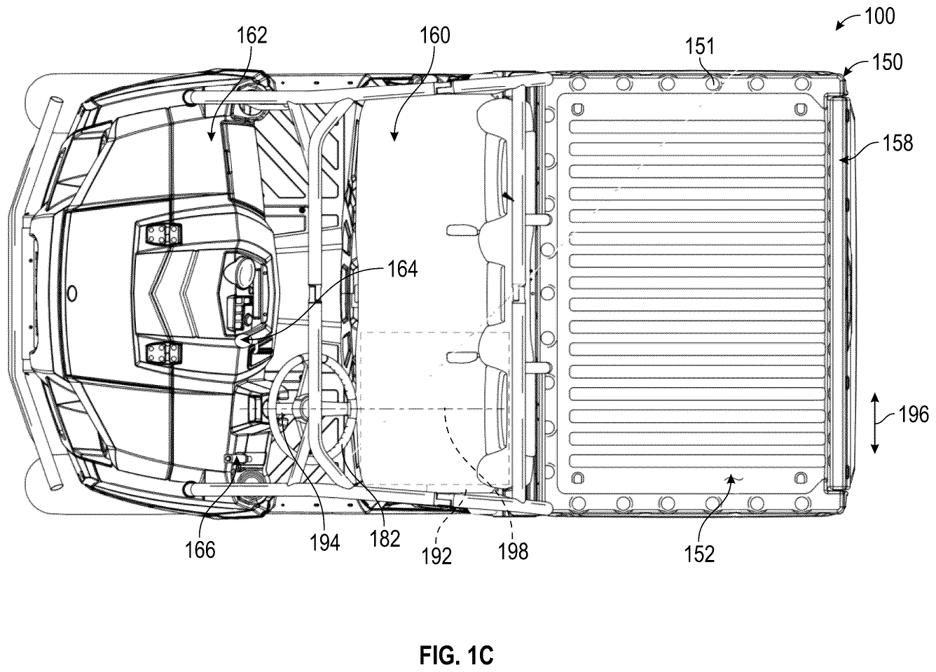

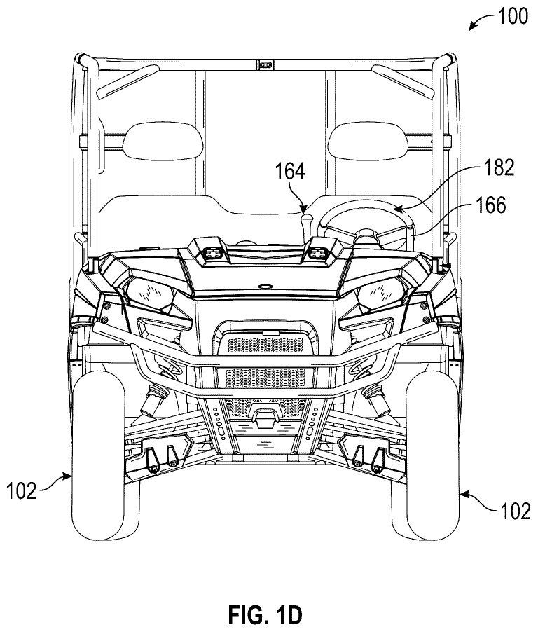

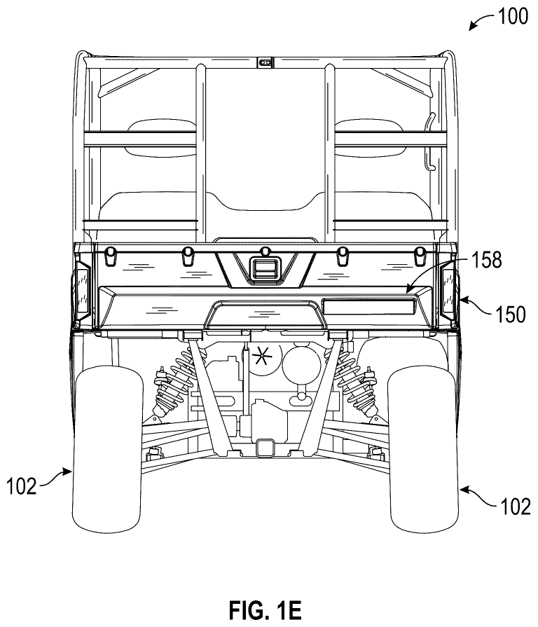

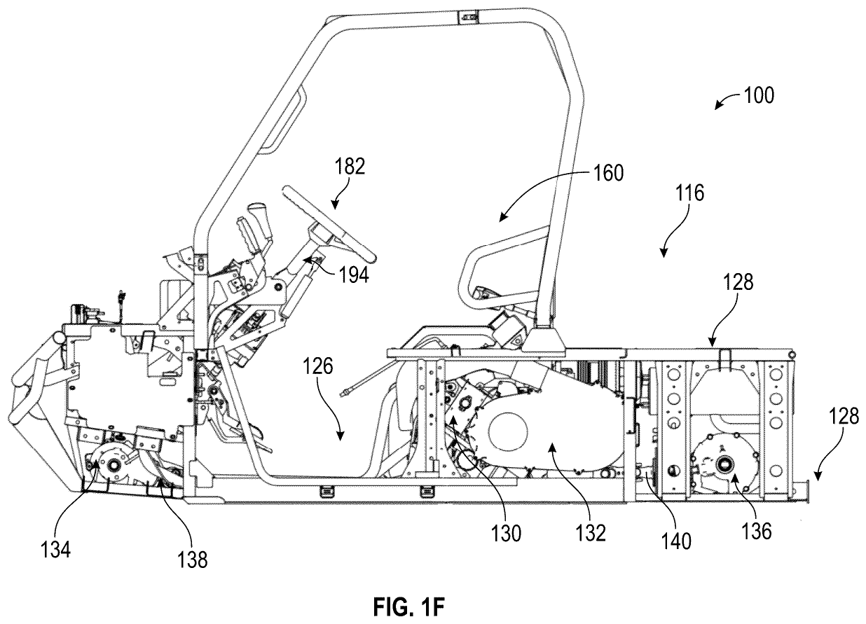

With reference to FIGS. 1A-1F, an illustrative embodiment of a vehicle 100 is shown. Vehicle 100 as illustrated includes a plurality of ground engaging members 102. Illustratively, ground engaging members 102 are wheels 104 and associated tires 106. Other example ground engaging members include skis and tracks. In one embodiment, one or more of the wheels may be replaced with tracks, such as the Prospector Pro Tracks available from Polaris Industries, Inc. located at 2100 Highway 55 in Medina, MN 55340.

As mentioned herein, one or more of ground engaging members 102 are operatively coupled to a power source 130 (see FIG. 1F) to power the movement of vehicle 100. Example power sources include combustion engines and electric motors.

Referring to the illustrated embodiment in FIG. 1A, a first set of wheels, one on each side of vehicle 100, generally correspond to a front axle 108. A second set of wheels, one on each side of vehicle 100, generally correspond to a rear axle 110. Although each of front axle 108 and rear axle 110 are shown having a single ground engaging members 102 on each side, multiple ground engaging members 102 may be included on each side of the respective front axle 108 and rear axle 110.

As configured in FIG. 1A, vehicle 100 is a four-wheel, two-axle vehicle. In one embodiment, one or more modular subsections (not pictured) may be added to vehicle 100 to transform vehicle 100 into a three-axle vehicle, a four-axle vehicle, and so on. For example, modular subsections may include a frame that is coupled to a frame 116 (see FIG. 1B) of vehicle 100, which may be supported by ground engaging members associated therewith. Such a frame may be coupled to frame 116 through a plurality of connections points, such that the frame does not rotate relative to frame 116.

Vehicle 100 includes an operator area 160 generally supported by operator area portion 126 (FIG. 1F) of frame 116. Operator area 160 includes seating 161 for one or more passengers. While vehicle 100 is illustrated as including one row of seating 161, it will be appreciated that, in other examples, any number of rows of seating (e.g., a second row of seating and, in some examples, a third row of seating) may be provided. Operator area 160 further includes a plurality of operator controls 180 by which an operator may provide input into the control of vehicle 100. Operator controls 180 include a steering wheel 182, which is rotated by the operator to change the orientation of one or more of ground engaging members 102, such as the wheels associated with front axle 108, to steer vehicle 100. In one embodiment, steering wheel 182 changes the orientation of the wheels of front axle 108 and rear axle 110 to provide four-wheel steering. In examples, operator controls 180 also include a first foot pedal actuatable by the vehicle operator to control the acceleration and speed of vehicle 100 through the control of power source 130 (FIG. 1F) and a second foot pedal actuatable by the operator to decelerate vehicle 100 through a braking system.

As shown in FIGS. 1B-1D, operator controls 180 further include gear shift input control 164, which is operatively coupled to the shiftable transmission of transmission 132 (FIG. 1F) to communicate whether the shiftable transmission is in a low forward gear, a high forward gear, a reverse gear, neutral, and if included a park position. Although gear shift input control 164 is shown as a lever, other types of inputs may be used. Gear shift input control 164 is positioned on the right hand side of steering column 194.

Operator controls 180 further include a parking brake input control 166, as shown in FIGS. 1C and 1D. Parking brake input control 166 is operatively coupled to a parking brake of vehicle 100. In one embodiment, the parking brake is positioned on one of drive line 138 and drive line 140 (FIG. 1F). In one embodiment, a master cylinder that is operatively coupled to parking brake input control 166 is positioned underneath a dashboard body member 162. Although, parking brake input control 166 is shown as a lever, other types of inputs may be used. Parking brake input control 166 is positioned on a left hand side of steering column 194.

Referring to FIG. 1C, a vehicle operator position 192 on seating 161 (FIG. 1A) is represented. As shown in FIG. 1C, a steering column 194 of steering wheel 182 is centered side-to-side (arrows 196) as indicated by line 198 in the vehicle operator position 192.

Vehicle 100 is further illustrated as comprising a bed 150 having a cargo-carrying surface 152. Cargo-carrying surface 152 may be flat, contoured, and/or comprised of several sections. In one embodiment, bed 150 is rigidly coupled to frame 116. In one embodiment, bed 150 is rotatably coupled to frame 116 and may be tilted so that a front portion 154 is higher relative to back portion 156. Back portion 156 includes a tailgate 158, which may be lowered to improve ingress to and egress from bed 150. Bed 150 further includes a plurality of mounts 151 for receiving an expansion retainer (not shown) which may couple various accessories to bed 150. Additional details of such mounts and expansion retainers are provided in U.S. Pat. No. 7,055,454, to Whiting et al., filed Jul. 13, 2004, titled “Vehicle Expansion Retainer”, the disclosure of which is expressly incorporated by reference herein. When a modular subsection is coupled to vehicle 100, bed 150 may be replaced with a longer bed or platform, which extends over such a modular subsection.

Turning to FIG. 1F, a power source 130, illustratively a combustion engine, is supported by frame 116. In one embodiment, power source 130 is a multifuel engine capable of utilizing various fuels. An example multifuel engine capable of utilizing various fuels is disclosed in U.S. patent application Ser. No. 11/445,731, filed Jun. 2, 2006, Docket No. PLR-00-1505.01P, the disclosure of which is expressly incorporated by reference herein. In one embodiment, power source 130 is a hybrid electric engine. In another embodiment, power source 130 may include one or more electric motors and one or more batteries.

Power source 130 is coupled to a front differential 134 and a rear differential 136 through a transmission 132 and respective drive line 138 and drive line 140. Drive line 138 and drive line 140, like other drive lines mentioned herein, may include multiple components and are not limited to straight shafts. For example, front differential 134 may include two output shafts (not pictured), each coupling a respective ground engaging members 102 of front axle 108 to front differential 134. In a similar fashion, rear differential 136 includes two output shafts, each coupling a respective ground engaging members 102 of rear axle 110 to rear differential 136. In other examples, one or more power sources 130, such as one or more electric motors, may be directly coupled to one or more respective ground engaging members 102.

In one embodiment, transmission 132 may include a shiftable transmission and/or a continuously variable transmission (“CVT”). For example, the CVT is coupled to power source 130 and to the shiftable transmission. The shiftable transmission is coupled to drive line 138, which is coupled to front differential 134 and to drive line 140, which is coupled to rear differential 136. In one embodiment, the shiftable transmission is shiftable between a high gear for normal forward driving, a low gear for towing, and a reverse gear for driving in reverse. In one embodiment, the shiftable transmission further includes a park setting, which locks the output drive of the shiftable transmission from rotating. Example shiftable transmissions and CVTs are disclosed in U.S. Pat. Nos. 6,725,962 and 6,978,857, the disclosures of which are expressly incorporated by reference herein. In other examples, one or more axles (e.g., axle 108 or 110) may be non-powered axles.

Various configurations of front differential 134 and rear differential 136 are contemplated. Regarding front differential 134, in one embodiment front differential 134 has a first configuration wherein power is provided to both of the ground engaging members 102 of front axle 108 and a second configuration wherein power is provided to one of ground engaging members 102 of front axle 108.

Regarding rear differential 136, in one embodiment rear differential 136 is a locked differential wherein power is provided to both of the ground engaging members 102 of rear axle 110 through the output shafts. When rear differential 136 is in a locked configuration, power is provided to both wheels of rear axle 110. When rear differential 136 is in an unlocked configuration, power is provided to one of the wheels of rear axle 110.

Additional discussion of vehicle 100 and related aspects are disclosed in U.S. Pat. No. 7,950,486, the disclosure of which is expressly incorporated by reference herein. Further, it will be appreciated that vehicle 100 is provided for illustrative purposes and, in other examples, aspects described herein may similarly be applicable to any of a variety of other vehicles, including, but not limited to, an all-terrain vehicle (ATV), a side-by-side (S×S) vehicle, an off-road vehicle, a two- or three-wheeled motorcycle, a snowmobile, or a personal transport vehicle.

### Portable Workbench.

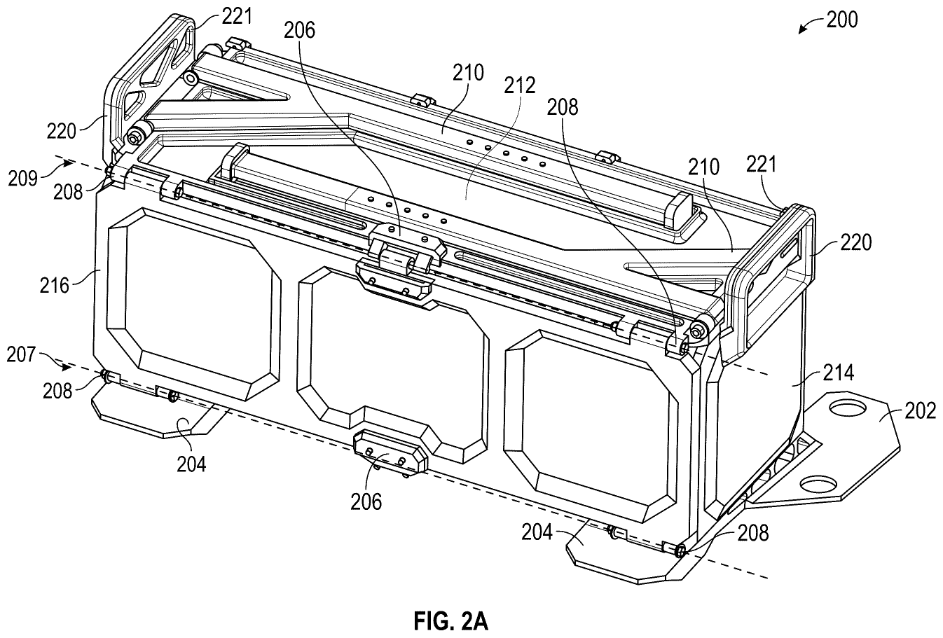

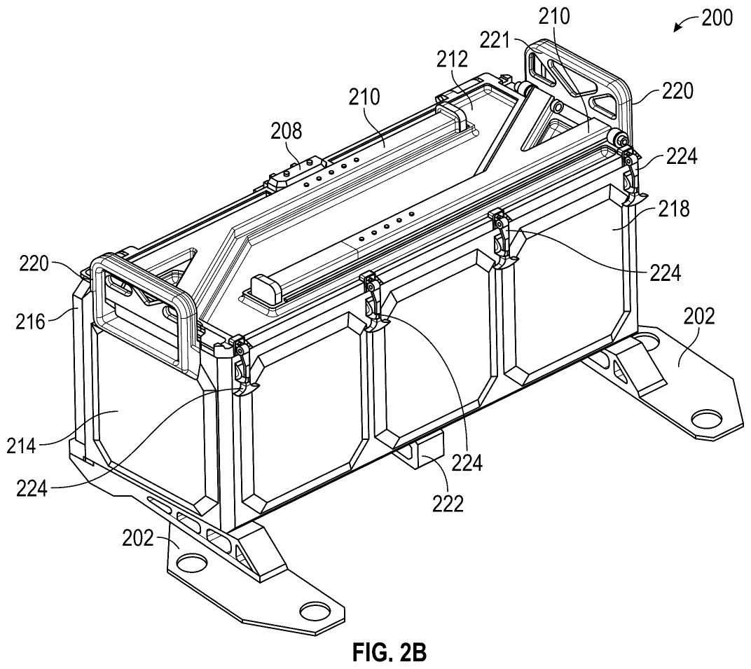

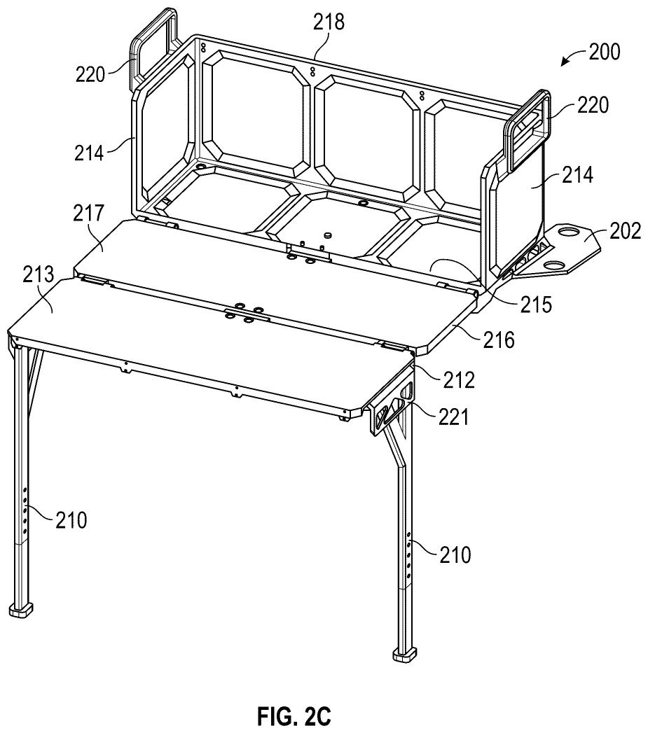

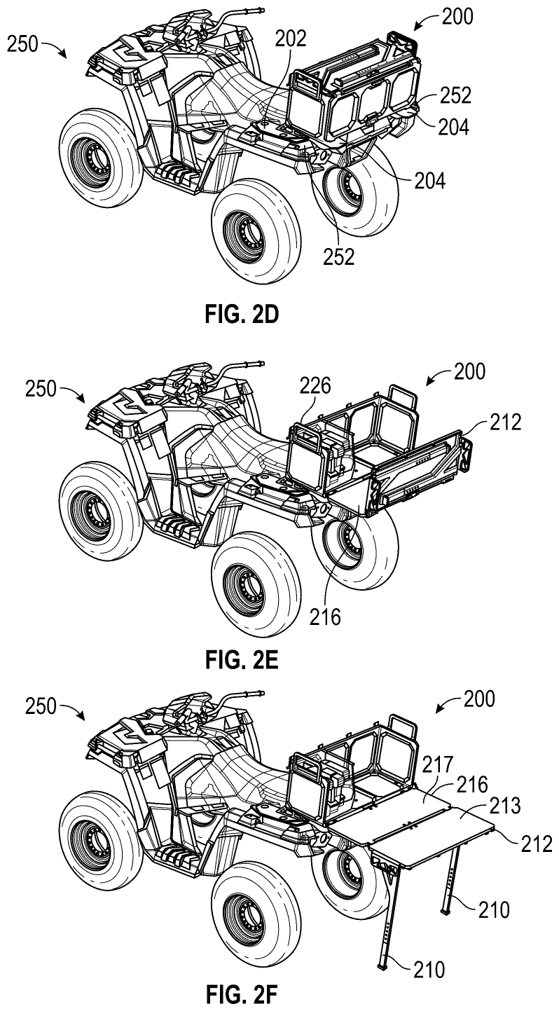

FIGS. 2A-2F illustrate an example portable work surface assembly 200 for attachment to a vehicle according to aspects described herein. For example, portable work surface assembly 200 is removably coupled to vehicle 100 discussed above with respect to FIGS. 1A-1F. As another example, portable work surface assembly 200 is removably coupled to an ATV (e.g., vehicle 250 in FIGS. 2D-2F).

Thus, it will be appreciated that a similar portable work surface assembly may be used for any of a variety of vehicles. As an example, portable work surface assembly 200 includes mount 202 that is used to couple portable work surface assembly 200 to the vehicle (e.g., rear member 252 of vehicle 250 in FIG. 2D), which may thus be substituted or otherwise adapted to enable the same or a similar portable work surface assembly 200 to be used in conjunction with a variety of other vehicles. As another example, multiple, similar instances of a portable work surface assembly may be used, where a first instance of the portable work surface assembly has a first set of dimensions and a second instance of the portable work surface assembly has a second set of dimensions. For example, the portable work surface assembly may be provided in a small, medium, and/or a large size, among other examples. In examples, the small, medium, and large sizes each have one or more corresponding mounts 202 that are each associated with a vehicle to which the portable work surface assembly is to be mounted.

Turning now specifically to FIGS. 2A and 2B, portable work surface assembly 200 includes top panel 212, side panels 214, front panel 216, rear panel 218 (FIG. 2B), and bottom panel 215 (FIG. 2C). In examples, panels 214, 218, and/or 215 (FIG. 2C) may be formed as a single part or may be a number of panels that are mechanically and/or adhesively coupled, among other examples.

Thus, in a closed configuration, panels 212, 214, 216, 218, and 215 form a cavity in which any of a variety of items may be stored (e.g., clamps, a drill and/or other tools, straps, vices, various hardware for a specific task/project, containers, tool bags, clothing, coolers, food/beverages, lumber, etc.). As illustrated in FIG. 2E, portable work surface assembly 200 may further include container 226, thereby enabling organization of items that are stored within portable work surface assembly 200 accordingly. Alternatively, or additionally, one or more anchors are included within the cavity, which may thus be used to secure various items inside, for example using one or more rachet straps and/or bungie cords, among other examples. In examples, the closed configuration of portable work surface assembly 200 provides a cavity that is substantially sealed (e.g., from dust and/or water). In other examples, the cavity need not be sealed.

As illustrated, top panel 212 is fastened to rear panel 218 using latches 224. It will be appreciated that, while portable work surface assembly 200 is illustrated as including four latches, any number of latches may be used in other examples. In some examples, one or more of latches 224 are lockable, such that the content of portable work surface assembly 200 may be secured accordingly.

Top panel 212 and front panel 216 are illustrated as being coupled via friction hinge 206 and hinges 208, while top panel 212 and bottom panel 215 are similarly coupled via friction hinge 206 and hinges 208. While the illustrated example includes one friction hinge 206 and two hinges 208, it will be appreciated that, in other examples, any number of such hinges may be used. Friction hinge 206 is included to restrict movement of panels 212 and 216 (e.g., while portable work surface assembly 200 is transitioning from an open to a closed configuration, or vice versa), such that, absent actuation by an individual, panel 212 and/or 216 remains substantially in-place.

Portable work surface assembly 200 is further illustrated as including handles 220, each of which correspond to features 221 of top panel 212. In an open configuration (e.g., FIGS. 2C and 2F), features 221 may prevent support members 210 from over-rotating when extended, which may have an adverse effect on the stability of the work surface (e.g., including surface 213 of top panel 212 and surface 217 of front panel 216) that is provided by portable work surface assembly 200. In other examples, handles 220 and/or features 221 may be omitted.

Portable work surface assembly 200 further includes mount 202 and bump stops 204. As noted above, mount 202 may be removably coupled to bottom panel 215, such that mount 202 may be substituted with another mount, for example to achieve compatibility with another vehicle. Mount 202 further includes support bracket 222 (FIG. 2B), which supports bottom panel 215.

As illustrated, mount 202 is angled, such that front panel 216 is lower than rear panel 218, as compared to the bottom surface of mount 202. Thus, in the illustrated example, mount 202 may adapt portable work surface assembly 200 to corresponding geometry of the vehicle on which portable work surface assembly 200 is to be installed, thereby ensuring that bottom panel 215 is substantially parallel to the ground (when the vehicle is on level terrain), even if the rear member to which portable work surface assembly 200 is coupled (e.g., rear member 252 in FIG. 2D) is not substantially parallel and/or flat. While the present example is depicted in an example in which mount 202 is angled, it will be appreciated that any of a variety of other geometries may be used for mount 202.

As illustrated, each mount 202 includes two holes through which a fastener may extend. Example fasteners include, but are not limited to, a bolt (which may thus be secured using a corresponding bolt or threaded portion of a vehicle member thereunder), a corresponding feature of the vehicle (e.g., a protrusion), and/or a latch. As another example, an expansion retainer may be used.

Portable work surface assembly further includes bump stops 204, which are provided to support front panel 216 as portable work surface assembly 200 transitions to an open configuration (e.g., FIG. 2E) and/or once portable work surface assembly 200 is in the open configuration (e.g., FIGS. 2C and 2F).

Thus, as an individual causes front panel 216 to rotate around axis 207 (FIG. 2A), front panel 216 comes to rest on bump stops 204, as illustrated in FIG. 2E. Accordingly, support members 210 may be rotated outward and top panel 212 is rotated around axis 209, thereby configuring portable work surface assembly 200 according to its open configuration. As illustrated, support members 210 are telescopic, such that the individual may adjust the length of support members 210 accordingly (e.g., to account the height of a given vehicle and/or to account for uneven terrain, among other examples). In examples, each of support members 210 are independently adjustable, such that the length of each support member is adjusted to account for uneven terrain. In some examples, one or more support members 210 includes markings (e.g., corresponding to millimeters, inches, and/or feet) to enable an individual to determine a corresponding height. For instance, such markings may be used to ensure each support member is similarly extended, thereby providing a substantially level work surface. It will be appreciated that any of a variety of mechanisms may be used to permit or restrict telescoping by support members 210, including, but not limited to, quick-release collars/clamps or a push-button release, among other examples.

Thus, once portable work surface assembly 200 is in an open configuration, a work surface is provided. As illustrated in FIGS. 2C and 2F, the resulting work surface includes surface 213 of top panel 212 and surface 217 of front panel 216, each of which are, as illustrated, substantially flat. Thus, the provided work surface may be used for cutting, clamping, and/or to mount a vice, among other examples. It will be appreciated that any of a variety of other surfaces may be provided. For example, the surface of bottom panel 215 may similarly be flat or, as another example, surfaces 213 and/or 217 may each be rough and/or may have grooves to improve friction between the provided work surface and objects placed thereon.

### Portable Work Surface (e.g., for a UTV).

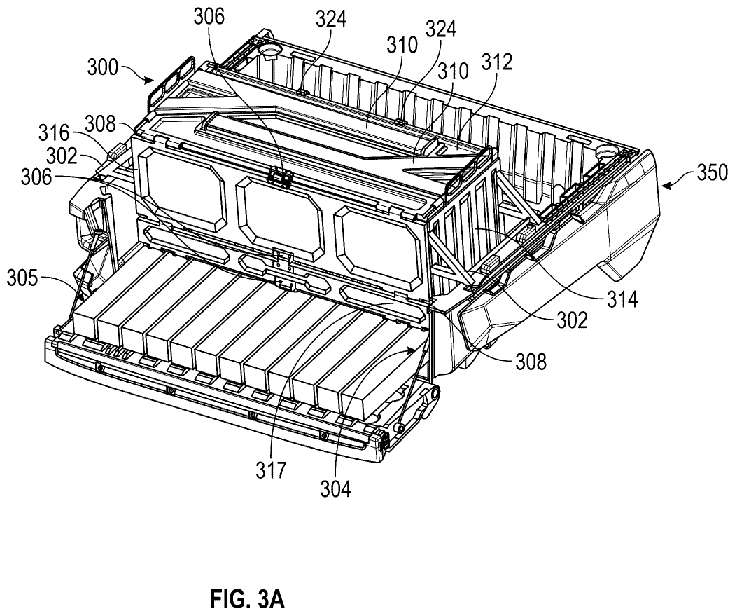

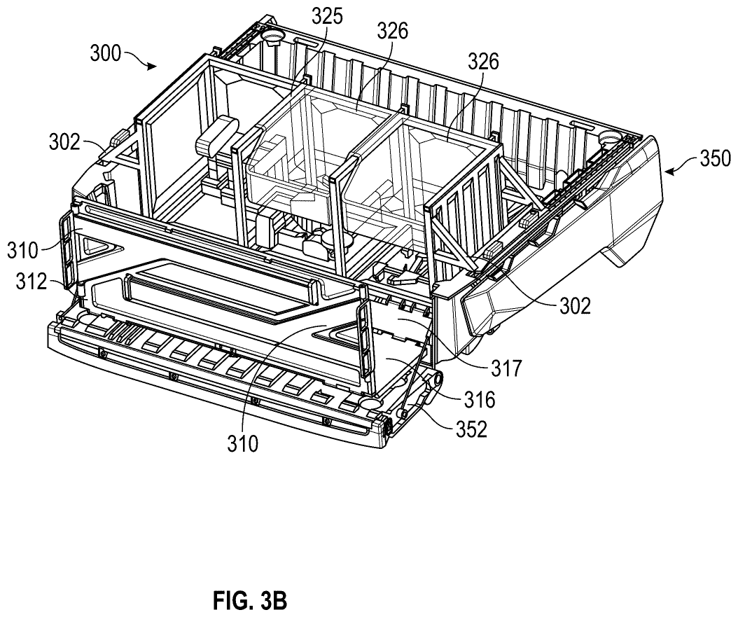

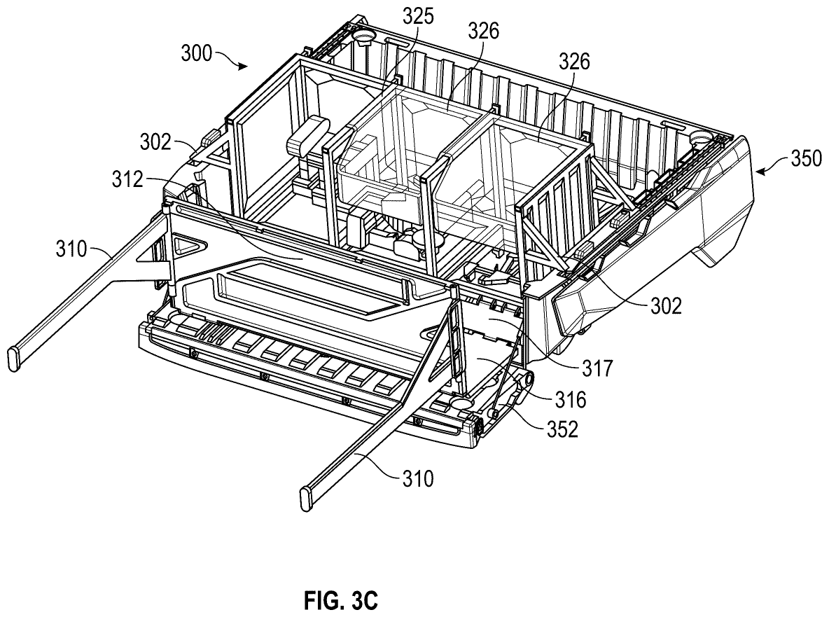

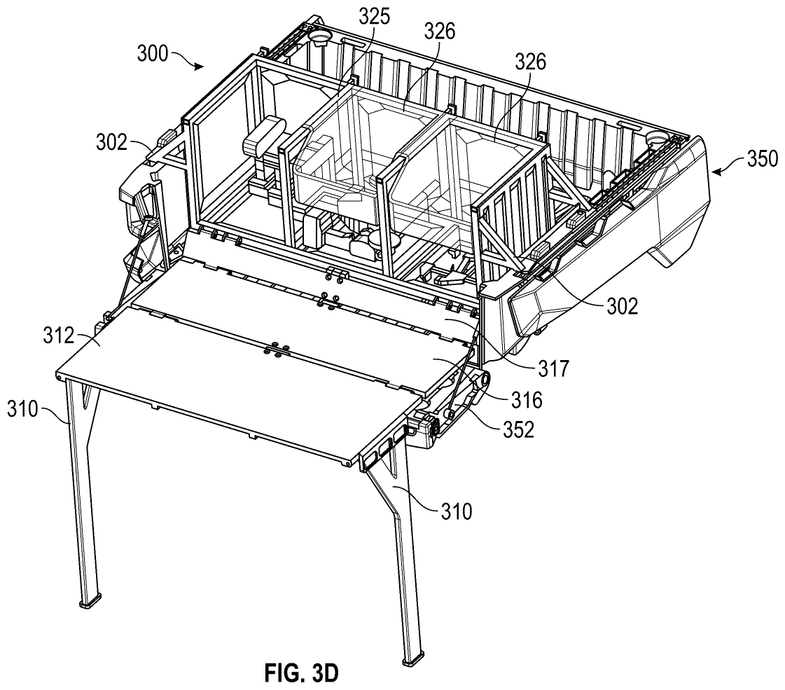

FIGS. 3A-3D illustrate another example a portable work surface assembly 300 for attachment to a vehicle (e.g., in vehicle bed 350) according to aspects described herein. For example, portable work surface assembly 300 is removably coupled to vehicle 100 discussed above with respect to FIGS. 1A-1F. For instance, portable work surface assembly 300 may be placed within bed 150 of vehicle 100 and fastened within bed 150 using mounts 151. Mount 302 of portable work surface assembly 300 may thus include one or more openings that are similarly spaced to mounts 151 through which expansion retainers may pass, thereby anchoring portable work surface assembly 300 to bed 150 of vehicle 100 accordingly. It will be appreciated that any of a variety of additional or alternative fasteners and/or mounts may be used in other examples. Additional example aspects of fasteners that may be used according to aspects of the present disclosure are described in U.S. Provisional Application No. 63/357,204, the disclosure of which is expressly incorporated by reference herein.

Similar to mount 202 of portable work surface assembly 200, mount 302 may be substituted or otherwise adapted to enable the same or a similar portable work surface assembly 300 to be used in conjunction with a variety of other vehicles. As another example, multiple, similar instances of a portable work surface assembly may be used, where a first instance of the portable work surface assembly has a first set of dimensions and a second instance of the portable work surface assembly has a second set of dimensions. For example, the portable work surface assembly may be provided in a small, medium, and/or a large size, among other examples. In examples, the small, medium, and large sizes each have one or more corresponding mounts 302 that are each associated with a vehicle to which the portable work surface assembly is to be mounted. Any of a variety of alternative or different fasteners may be used in other examples.

Aspects of portable work surface assembly 300 may be similar to those discussed above with respect to portable work surface assembly 200 and are therefore not redescribed. For example, portable work surface assembly 300 includes a set of panels that form a cavity for storage which, as illustrated, include top panel 312, side panel 314, top front panel 316, and bottom front panel 317, which are coupled using hinges 306 and friction hinges 308. Aspects of panels 312, 314, and 316 and hinges 306 and 308 may be similar to panels 212, 214, and 216 and hinges 206 and 208, respectively, discussed above with respect to FIGS. 2A-2F. Further, similar to portable work surface assembly 200, latches 324 (aspects of which may be similar to latches 224) are used to secure top panel 312 to the back panel of portable work surface assembly 300 in a closed configuration, while top panel 312 is supported by support members 310 (which may be similar to support members 210) in an open configuration.

With reference to FIG. 3A, as compared to portable work surface assembly 200, portable work surface assembly 300 is removably coupled to the sides of vehicle bed 350 by mounts 302, which are located at the sides of portable work surface assembly 300. Thus, gap 304 is formed between portable work surface assembly 300 and the bottom of bed 350, such that example objects 305 (e.g., dimensional lumber, as illustrated) may be stored beneath portable work surface assembly 300 accordingly. Gap 304 may be fixed or may be adjustable (e.g., as a result of positioning/repositioning mounts 302 accordingly).

Additionally, as compared to front panel 216 of portable work surface assembly 200, the front panel of portable work surface assembly 300 includes top front panel 316 and bottom front panel 317. In examples, a length of bottom front panel 317 is selected such that top front panel 316 rests substantially flat on vehicle bed 350 in an open configuration (e.g., when objects 305 are removed from vehicle bed 350, as shown in FIG. 3B). Thus, bottom front panel 317 may be provided to account for the height difference between the bottom panel of portable work surface assembly 300 and vehicle bed 350 (e.g., that forms gap 304). It will be appreciated that, in other examples, portable work surface assembly 300 may rest on vehicle bed 350 or may otherwise be mounted such that bottom front panel 317 may be omitted.

Further, as compared to portable work surface assembly 200, portable work surface assembly 300 need not include bump stops (e.g., bump stops 204 in FIGS. 2A and 2D). Rather, as illustrated in FIGS. 3B and 3C, top front panel 316 is instead supported by tailgate 352. In other examples, one or more bump stops are included to restrict movement of bottom front panel 317 (e.g., as bottom front panel 317 is rotated as part of a transition from a closed configuration to an open configuration).

Portable work surface assembly 300 also includes frame 325, which may provide increased rigidity and, as illustrated, may further enable containers 326 to rest thereon and thus be elevated above the bottom panel of the portable work surface assembly 300 accordingly. Similar to portable work surface assembly 200, portable work surface assembly 300 may include one or more anchors to facilitate improved storage/organization. For example, frame 325 may include one or more such anchors. While examples of such aspects are illustrated with respect to portable work surface assembly 300, it will be appreciated that similar aspects may be included by portable work surface assembly 200 in other examples. As a further example, frame 325 may be omitted to yield a portable work surface assembly that is similar to portable work surface assembly 200 in FIGS. 2A-2F.

Finally, similar to FIGS. 2D-2F, FIGS. 3A-3D illustrate a progression in which portable work surface assembly 300 transitions from a closed configuration to an open configuration. More specifically, an individual may lower top front panel 316 such that it rests on tailgate 352, as illustrated in FIG. 3B. Accordingly, the individual may extend support members 310, as illustrated in FIG. 3C. Finally, top panel 312 may be lowered as illustrated in FIG. 3D, thereby forming a work surface on which the individual may work. While FIG. 3D illustrates top panel 312 as being partially supported by tailgate 352, it will be appreciated that, in other examples, top panel 312 may be sized and shaped such that top panel 312 is instead supported by support members 310 and top front panel 316 (e.g., via hinges 306 and/or 308). Such an example may similarly occur in instances where portable work surface assembly 300 is installed closer toward tailgate 352, among other examples.

Fold-Flat Cargo with Hinge System.

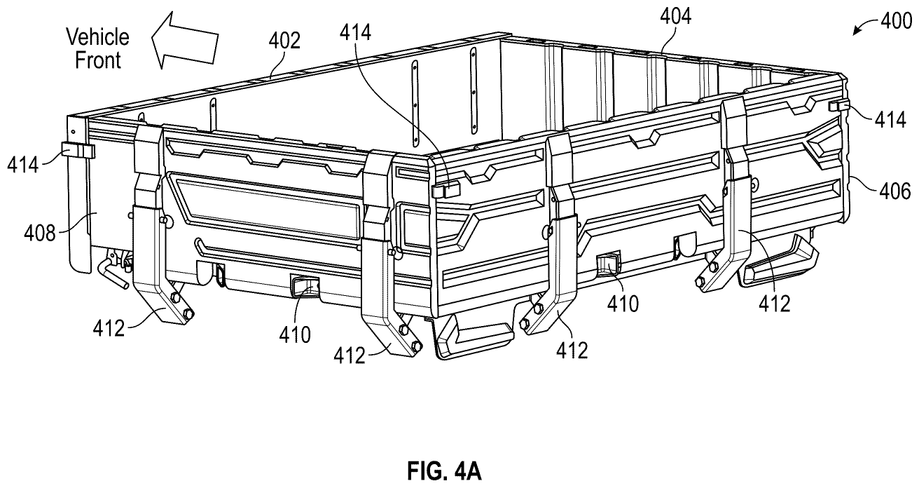

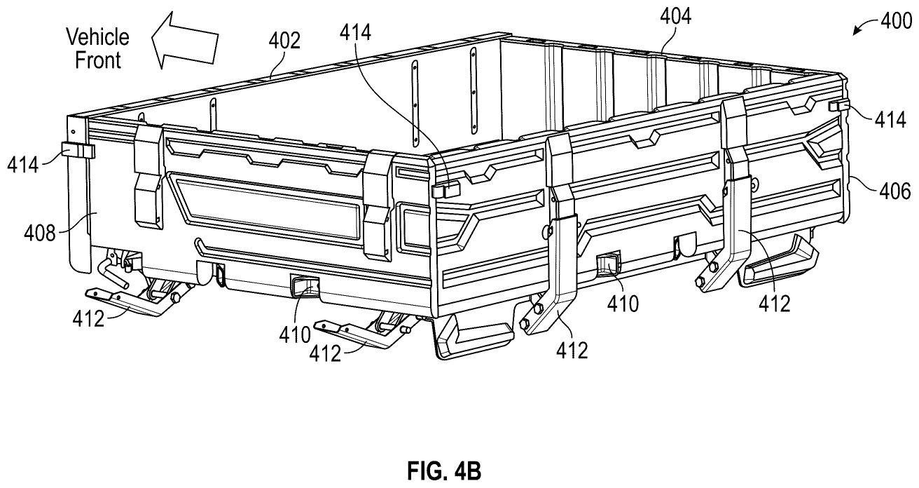

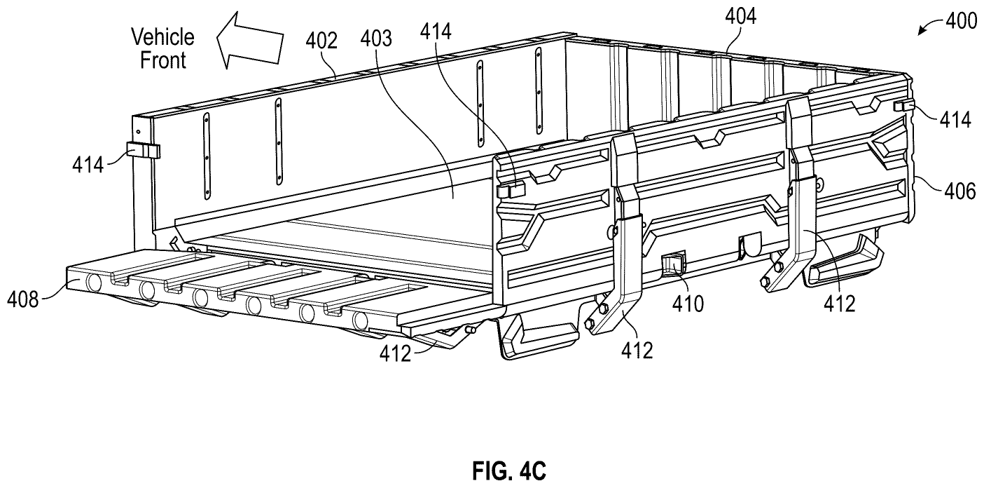

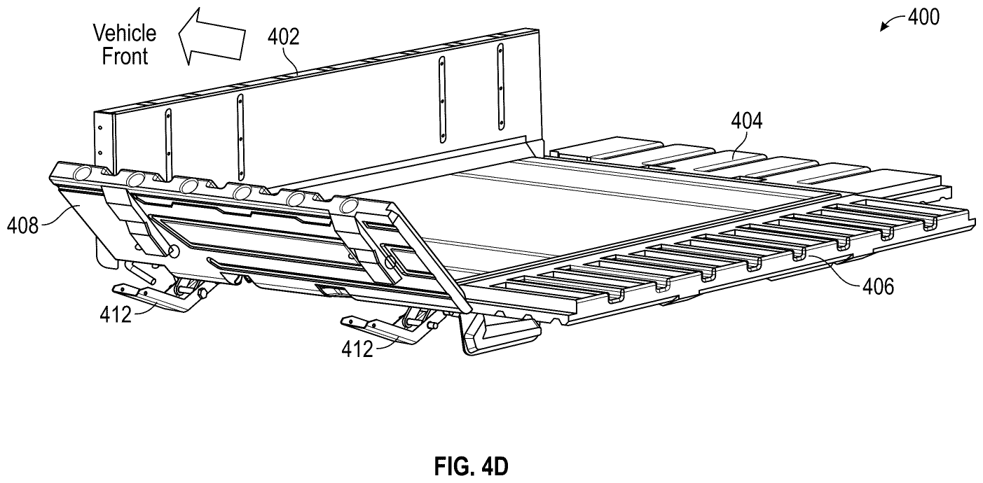

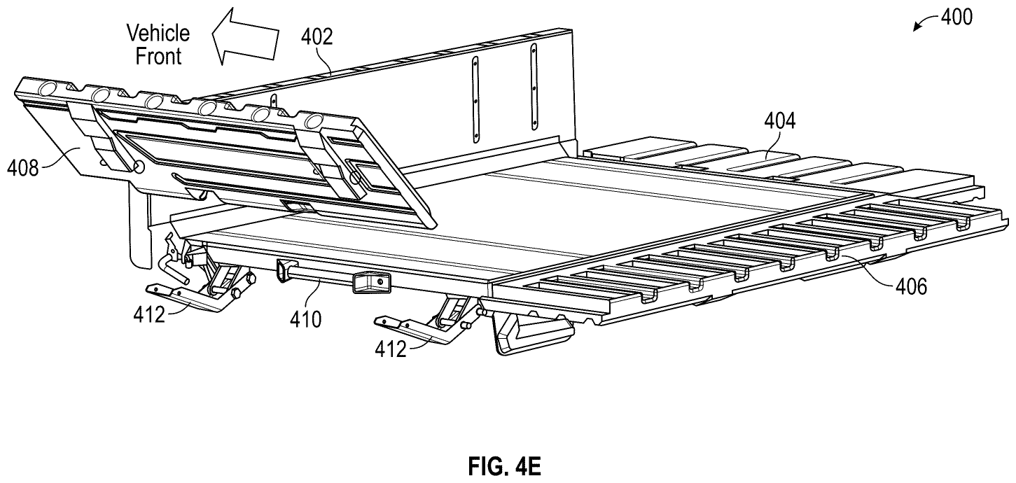

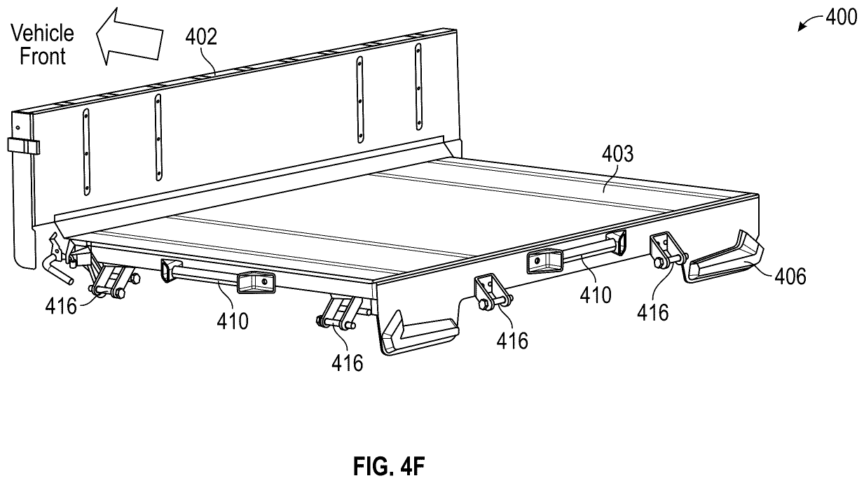

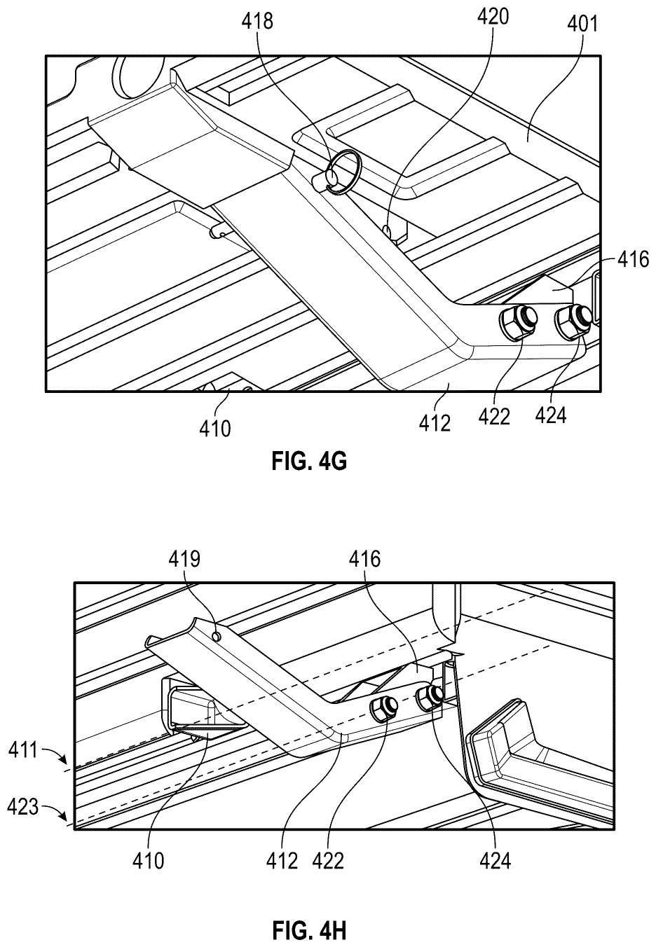

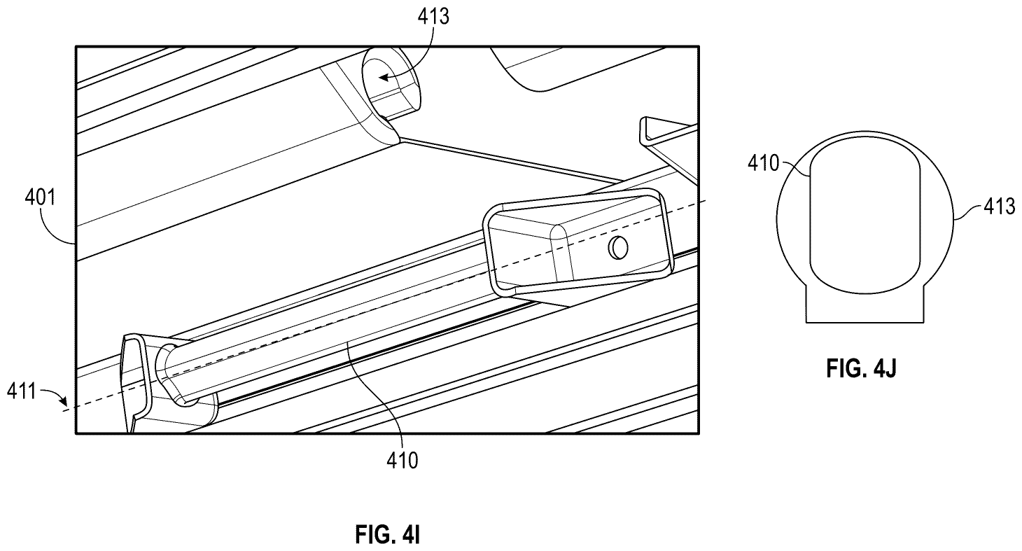

FIGS. 4A-4H illustrate example aspects of a cargo-carrying assembly 400, which may be a fold-flat cargo-carrying assembly, and may be positioned on or otherwise form a rear portion of a vehicle (e.g., vehicle 100 in FIGS. 1A-1F). For instance, cargo-carrying assembly 400 may be used on top of or in place of bed 150 of vehicle 100.

With reference to FIGS. 4A-4F, cargo-carrying assembly 400 includes front panel 402, side panels 404 and 408, rear panel 406 (which may function as a tailgate, in some examples), and cargo-carrying surface 403 (FIG. 4C). In examples, front panel 402 may be an existing part of a vehicle to which side panels 404 and 408 are removably coupled (e.g., via latch 414). Panels 404, 406, and 408 each have a vertical orientation, as illustrated, and a horizontal orientation (FIGS. 4C and 4E). Further, panels 404, 406, and/or 408 may be removed in some examples (FIGS. 4E and 4F). In the illustrated vertical orientation, panels 404, 406, and 408 are each secured by one hinge 410 (FIG. 4I) and two support members 412 (FIGS. 4G and 4H). Further, panels 404, 406, and 408 are each removably coupled to adjacent panels by latches 414.

As compared to other cargo-carrying assemblies (e.g., a cargo bed), cargo-carrying assembly 400 provides a locked configuration (e.g., where panels 404, 406, and 408 are each in a vertical configuration), a fold-flat configuration (e.g., where panels 404, 406, and 408 are each in a horizontal orientation), and a configuration in which panels 404, 406, and 408 are removed, or any combination thereof. The disclosed aspects provide a cargo-carrying assembly that need not have corner posts to support panels 404, 406, and/or 408 in either the horizontal configuration or vertical configuration. Further, in the fold-flat configuration (and, similarly, in a configuration in which one or more panels are removed), cargo-carrying assembly 400 is capable of carrying objects having one or more dimensions that exceed that of cargo-carrying surface 403, as nothing substantially protrudes from the plane formed by cargo-carrying surface 403, panel 404, panel 406, and/or panel 408, as may otherwise be the case if posts or other support members were used in one or more corners of cargo-carrying surface 403.

Turning now to FIGS. 4G and 4H, detail views of support member 412 are provided. As noted above, support member 412 supports a panel 401 (e.g., panel 404, 406, and/or 408) of cargo-carrying assembly 400 in both a horizontal orientation and a vertical orientation. FIG. 4G depicts panel 401 in a horizontal orientation, where pin 418 is used to secure support member 412 to panel 401, thereby substantially locking panel 401 in the horizontal orientation. As illustrated, panel 401 further includes opening 420, which may be used to substantially lock panel 401 in the vertical orientation (FIG. 4A). Thus, panel 401 includes two such openings (e.g., the opening in which pin 418 is disposed and opening 420), each associated with an orientation of panel 401.

Support member 412 is removably coupled to bracket 416, such that one or more support members 412 may be removed in some examples (e.g., FIG. 4F). In some instances, hinge 410 may be used as a tie-down point to secure one or more objects to cargo-carrying surface 403, as may be the case when one or more panels have been removed. It will be appreciated that bracket 416 may similarly be used as a tie-down point in some examples, as may be the case when support member 412 is removed from the bracket 416 according to aspects described herein. As illustrated, support member 412 is coupled to bracket 416 using fastener assembly 422 (e.g., including a nut and a corresponding bolt), though it will be appreciated that any of a variety of other coupling mechanisms may be used. For example, a quick-release pin may be used in another instance. Fastener assembly 424 is further provided as a bump stop to inhibit over-rotation of support member 412 around an axis defined by fastener assembly 422 (as illustrated by dashed line 423 in FIG. 4H), such that support member 412 supports panel 401 in the horizontal orientation accordingly. Given support member 412 rotates around axis 423 and panel 401 rotates around axis 411 (defined by hinge 410), coupling support member 412 to panel 401 thus locks panel 401 in a substantially horizontal or a substantially vertical orientation depending on the placement of pin 418.

Turning now to FIGS. 41 and 4J, detail views of hinge 410 are depicted. Hinge 410 interfaces with opening 413 of panel 401, such that panel 401 rotates around axis 411 (e.g., from a horizontal orientation to a vertical orientation, or vice versa). FIG. 4J provides a cross-sectional view of hinge 410 disposed within opening 413 of panel 401. As illustrated, hinge 410 is sized and shaped to permit rotation but also to permit separation of panel 401 from hinge 410 at a certain orientation. As an example, opening 413 and/or hinge 410 may be configured such that panel 401 can be separated from hinge 410 at approximately a 45-degree angle (as compared to a horizontal, or 0-degree, configuration for the panel), though it will be appreciated that any of a variety of other angles may be used in other examples (e.g., a 30-degree angle or a 60-degree angle). FIGS. 4D and 4E illustrate an example in which panel 408 is removed at such a separation angle accordingly. As illustrated, the separation angle of panel 401 from hinge 410 is thus controllable based on an orientation of the portion of hinge 410 that has a width that corresponds to the mouth of opening 413, such that rotating the portion around axis 411 may change the separation angle accordingly.

### Fold-Flat Cargo Box Side Panels Storage Rack.

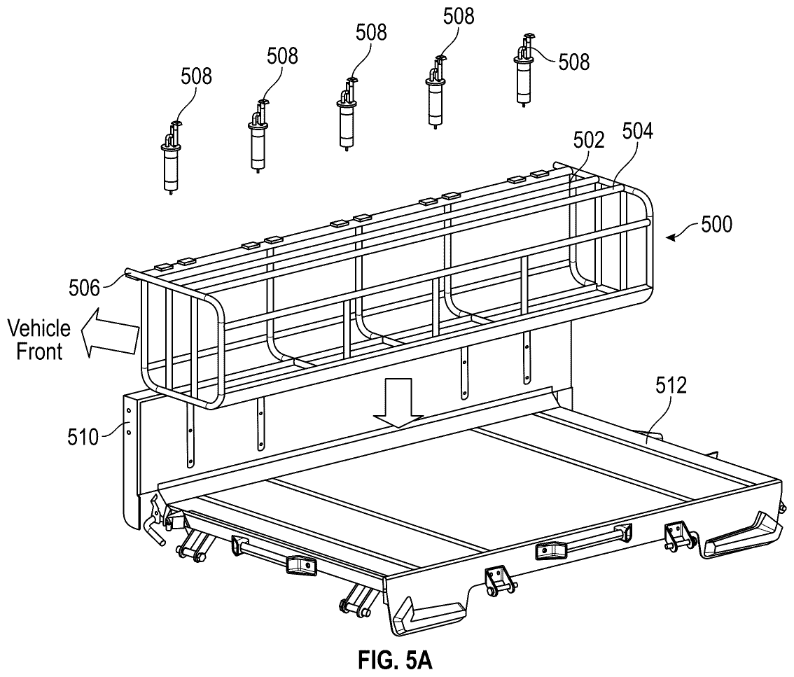

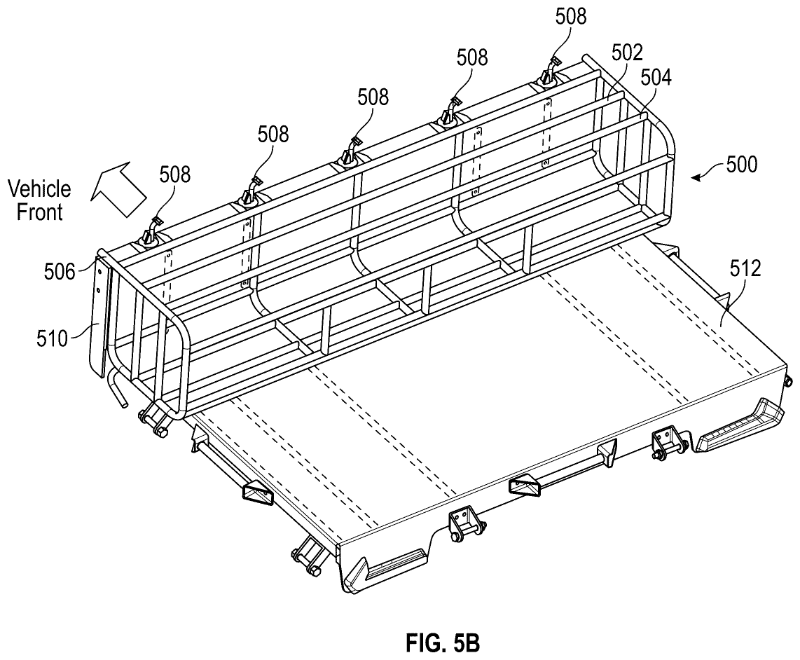

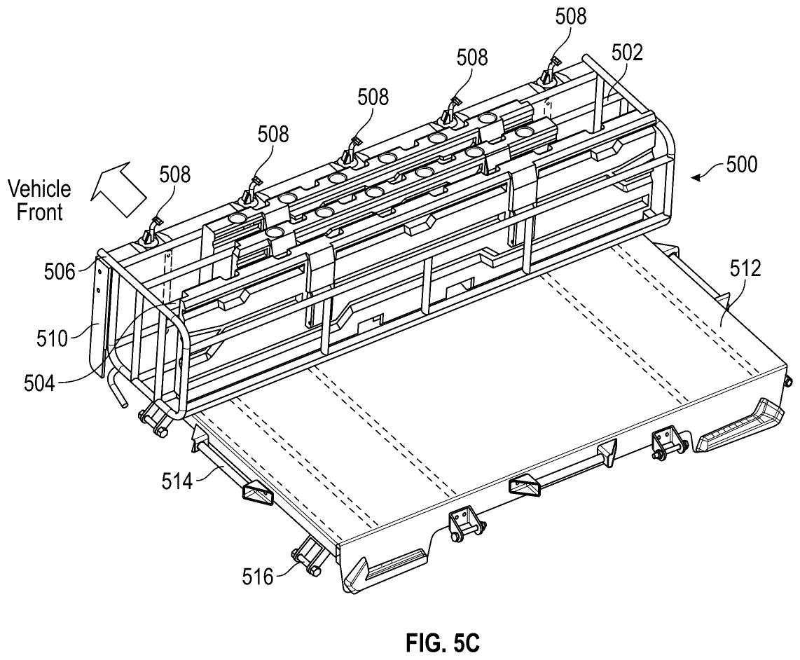

Turning now to FIGS. 5A-5C, storage rack 500 is provided. In examples, storage rack 500 is removably coupled to a vehicle (e.g., vehicle 100 in FIGS. 1A-1F). Storage rack 500 may be used to store one or more panels of a cargo-carrying assembly (e.g., panels 404, 406, and 408 of cargo-carrying assembly 400 in FIGS. 4A-4F).

As illustrated, storage rack 500 includes cross members 502 and 504, and mount 506. In examples, storage rack 500 rests on cargo-carrying surface 512 (FIG. 5B) and removably couples to front panel 510 of a vehicle cargo bed. Thus, storage rack 500 permits an individual to store and/or transport panels of a cargo-carrying assembly even in instances where the panels have been removed according to aspects described herein. As illustrated, storage rack 500 is removably coupled using expansion retainers 508, though it will be appreciated that any of a variety of additional or alternative fasteners may be used in other examples. Further, it will be appreciated that, while five expansion retainers 508 are illustrated, fewer or additional fasteners may be used in other examples.

FIG. 5C illustrates an example where storage rack 500 stores a set of panels (e.g., of a cargo-carrying assembly, such as cargo-carrying assembly 400 discussed above with respect to FIGS. 4A and 4F). For example, storage rack 500 stores a right panel, a left panel, and/or a tailgate panel of a cargo-carrying assembly. As illustrated, cross members 502 and 504 act as dividers (thereby forming three regions in which panels are stored) and thus restrict movement of panels stored therein in a longitudinal direction. In the illustrated examples, the panels may be stored in storage rack 500 in any order, but it will be appreciated that, in other examples, cross members 502 and 504 (as well as a variety of additional or alternative cross members) may be sized and shaped to retain a specific configuration of panels, for example thereby restricting lateral movement within storage rack 500.

Additionally, or alternatively, the panels are retained within storage rack 500 using one or more ties (e.g., bungee cords or rachet straps), which may be secured to the frame of storage rack 500, to front panel 510, and/or to one or more expansion retainers 508, among other examples. In the illustrated example, the panels are retained within storage rack 500 as a result of their weight and/or friction between other panels and/or cross members 502 and 504.

In examples, support members of the cargo-carrying assembly (e.g., support members 412 in FIGS. 4A and 4E and 4G and 4H) are also removed and stored. For example, the support members may be stored by storage rack 500 and/or may be stored within an operator area of the vehicle, among other examples. Further, it will be appreciated that storage rack 500 may be configured to store any of a variety of other items, including, but not limited to, containers 226 and/or 326 as were discussed above with respect to FIGS. 2E and 3B-3D. Finally, similar to the aspects noted above with respect to hinge 410 and/or bracket 416 in FIG. 4F, hinge 514 and/or bracket 516 may be used as tie-down points to secure one or more objects to cargo-carrying surface 512.

### Nested Storage Panels.

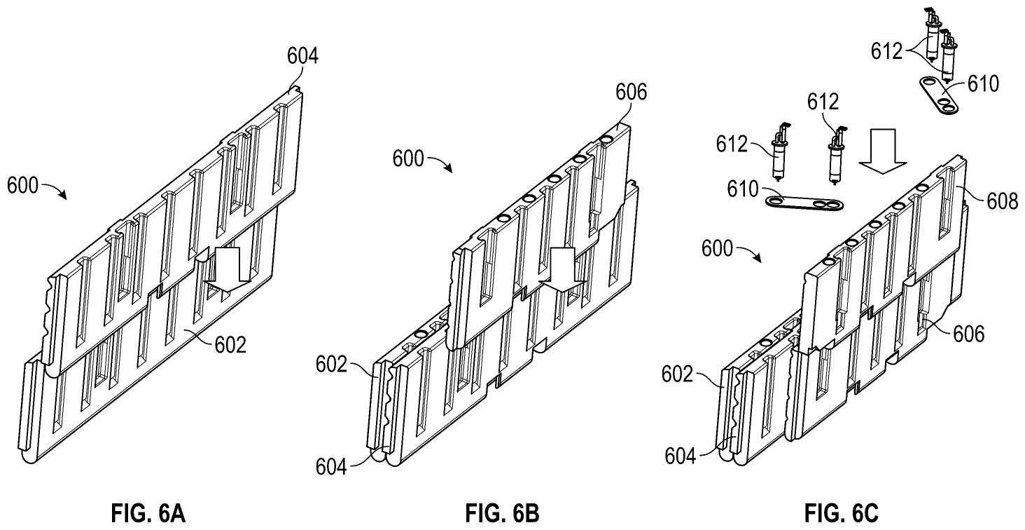

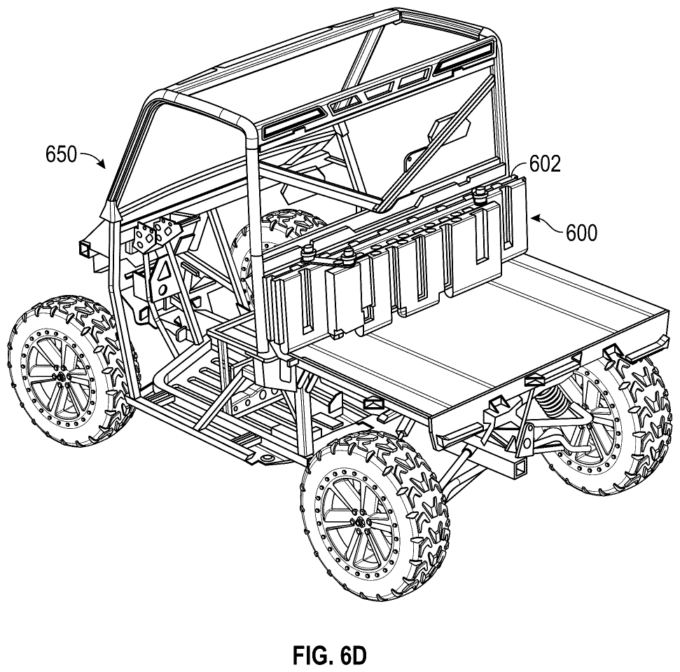

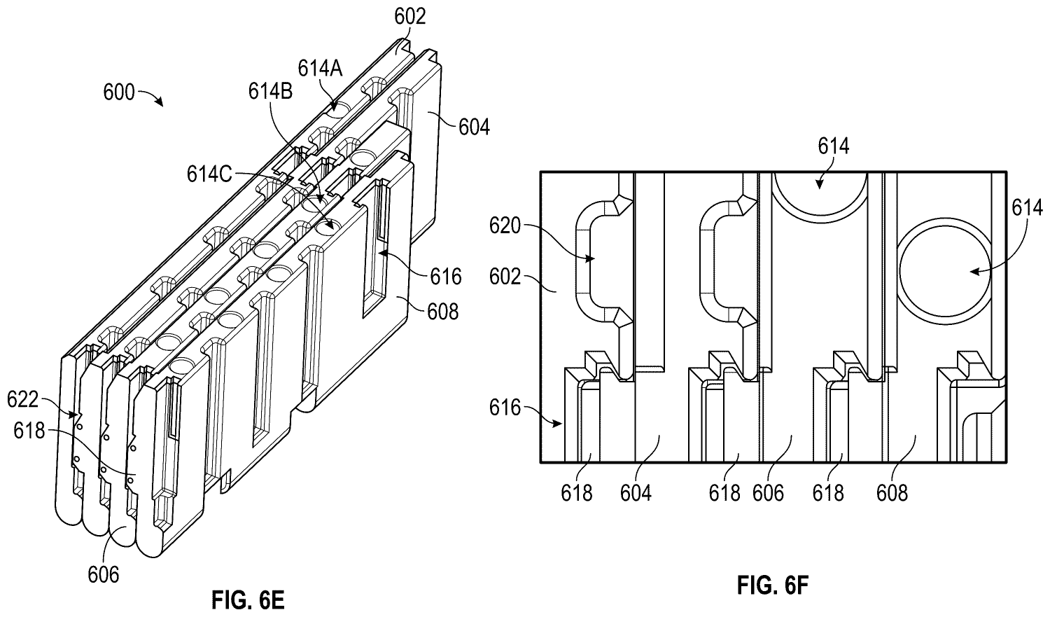

FIGS. 6A-6F illustrate example aspects of nesting panel assembly 600, which may be used by a vehicle (e.g., vehicle 100 in FIGS. 1A-1F) according to aspects described herein. For example, nesting panel assembly 600 may be formed from panels of a cargo-carrying assembly, thereby enabling storage of the panels when one or more such panels have been removed.

With reference to FIGS. 6A, 6B, and 6C, perspective views are shown where panels 604, 606, and 608, respectively, are successively nested. Front panel 602 may form a part of a vehicle (e.g., of a cargo bed, such as bed 150 of vehicle 100). For example, front panel 602 may be similar to front panel 402 and/or front panel 510 discussed above with respect to FIGS. 4A-4F and 5A-5C, respectively. As another example, front panel 602 may be removably coupled to the vehicle using one or more fasteners (e.g., expansion retainers and/or nuts/bolts).

As illustrated, panel 604 slots into panel 602, panel 606 slots into panel 604, and panel 608 slots into panel 606, thereby forming an example nested configuration of nesting panel assembly 600. While an example order is depicted, it will be appreciated that panels 604, 606, and 608 may be nested in any order and the disclosed techniques may be used for any number of panels. In an example, panel 604 is similar to rear panel 406, and panel 606 and 608 are each similar to side panel 404 and/or 408 of cargo-carrying assembly 400 discussed above with respect to FIGS. 4A-4E.

Turning to FIG. 6C, nesting panel assembly 600 further includes brackets 610 and fasteners 612. In examples, brackets 610 extend from front panel 602 to an outermost panel (e.g., panel 608 in the illustrated example), thereby securing intervening panels (e.g., panels 604 and 606), as illustrated in FIG. 6D. FIG. 6D is further provided to illustrate an example in which nesting panel assembly 600 is used with vehicle 650, thereby securing panels to front panel 602 of vehicle 650 according to aspects described herein.

It will be appreciated that, in some examples, there may be no intervening panels between front panel 602 and the outermost panel. Fasteners 612 are used to secure brackets 610, thereby restricting movement of the outermost panel and any intervening panels accordingly. As illustrated in FIG. 6C, brackets 610 include three openings, thereby accounting for different distances between front panel 602 and the outermost panel of nesting panel assembly 600 in a nested configuration. For example, the two outermost openings of brackets 610 are used when all four panels are nested, as illustrated (e.g., to span from opening 614A of panel 602 to opening 614C of panel 608 in FIG. 6E), while the outermost opening may be used in conjunction with the inner opening when only two or three panels are nested (e.g., to span from opening 614A of panel 602 to opening 614B of panel 606). For instance, side panels 606 and 608 may be nested, while tailgate panel 604 remains coupled to a corresponding hinge (e.g., hinge 410 in FIG. 4I; in a horizontal or a vertical configuration). As another example, tailgate panel 604 may be nested, while side panels 606 and 608 each remain coupled to a corresponding hinge. It will be appreciated that any number of such openings of a bracket 610 may be used, for example, to account for different numbers of panels that may be nested according to aspects described herein. Example nesting panel assembly 600 is illustrated as an example in which expansion retainers are used as fasteners 612, though it will be appreciated that any of a variety of additional or alternative fasteners may be used.

Turning now to FIGS. 6E and 6F, cross-sectional and top down detail views are provided of nesting panel assembly 600 in a nested configuration. As illustrated, a panel may include one or more channels 616, each of which are configured to receive a corresponding protrusion 618 of another panel. As illustrated, front panel 602 includes two channels 616 (FIG. 6E), which each receive a protrusion 618 of tailgate panel 604 accordingly. Similarly, tailgate panel 604 includes two channels 616 that each receive a corresponding protrusion 618 of side panel 606, and side panel 606 includes two channels 616 that each receive a corresponding protrusion 618 of side panel 608. It will be appreciated that any number of channels and corresponding protrusions may be used.

As illustrated, front panel 602 does not include protrusions, as front panel 602 nests only with one panel in the illustrated example. It will be appreciated that, in another example, the outermost panel (e.g., panel 608 in the illustrated example) may similarly omit channels 616, though such a design may limit the ordering of panels in the nested configuration. FIG. 6F illustrates an example geometry of protrusions 618, where protrusions 618 grow in width as they extend from the panel. Similarly, the width of channel 616 decreases toward the edge of the panel. Thus, protrusion 618 slidably couples with corresponding channel 616 in a first (e.g., vertical) direction, while restricting movement of the panel in the longitudinal and/or lateral direction(s).

In the illustrated example, panels 602, 604, 606, and 608 each further include channels 620, which are provided to improve rigidity. It will be appreciated that, in other examples, channels 620 may be removed. Panels 602, 606, and 608 each further include fastener openings 614, which, as noted above, may receive a fastener (e.g., an expansion retainer, see FIGS. 6C and 6D) with which to secure a bracket (e.g., bracket 610). Panel 604 is illustrated as an example where fastener openings 614 are omitted, though it will be appreciated that panel 604 may include one or more such openings and/or panels 602, 606, and 608 may include any number of such openings in other examples.

As illustrated in FIG. 6E, panels 604, 606, and 608 each include openings 622, which may correspond to a horizontal and a vertical configuration for each of panels 604, 606, and 608, examples of which were described above with respect to cargo-carrying assembly 400. Thus, protrusions 618 may further be used to provide such a cargo-carrying assembly, for example having a horizontal and a vertical orientation depending on where a pin is inserted to removably couple a support member to each protrusion 618 accordingly. Finally, while nesting panel assembly 600 is illustrated in an example where protrusion 618 is located substantially opposite to channel 616, it will be appreciated that protrusion 618 and channel 616 may be staggered or otherwise offset from one another (e.g., on opposing sides of a panel) in other examples.

### Fold-Flat Cargo Box.

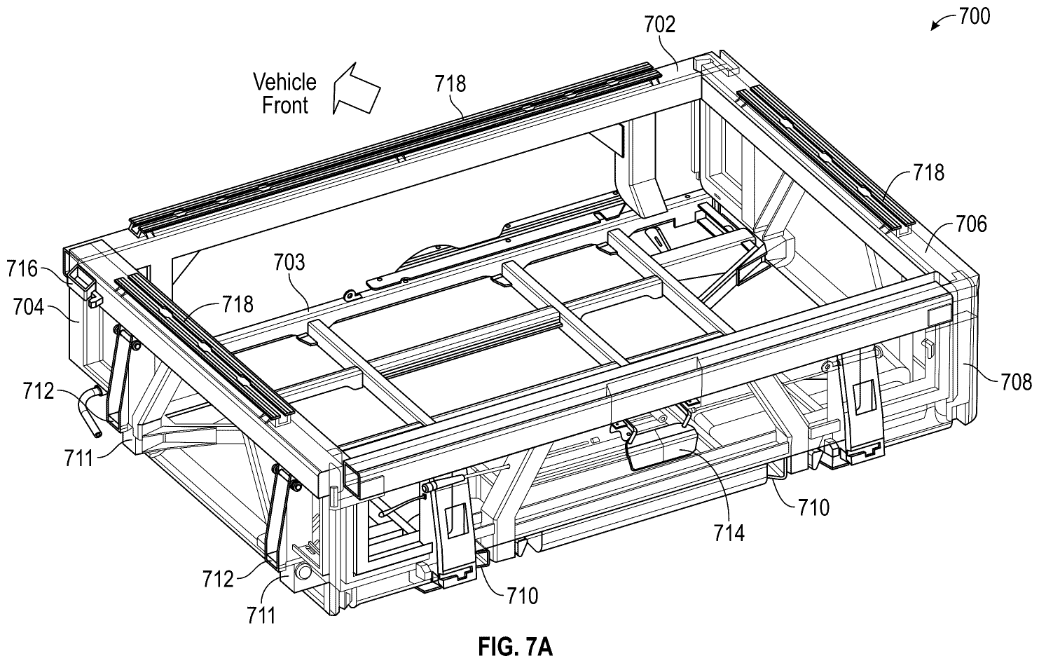

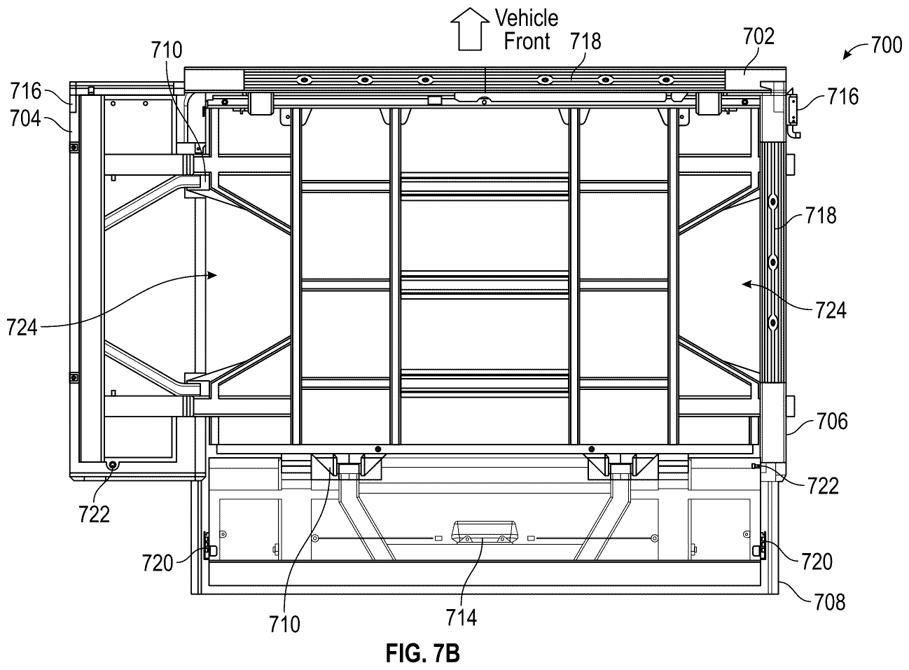

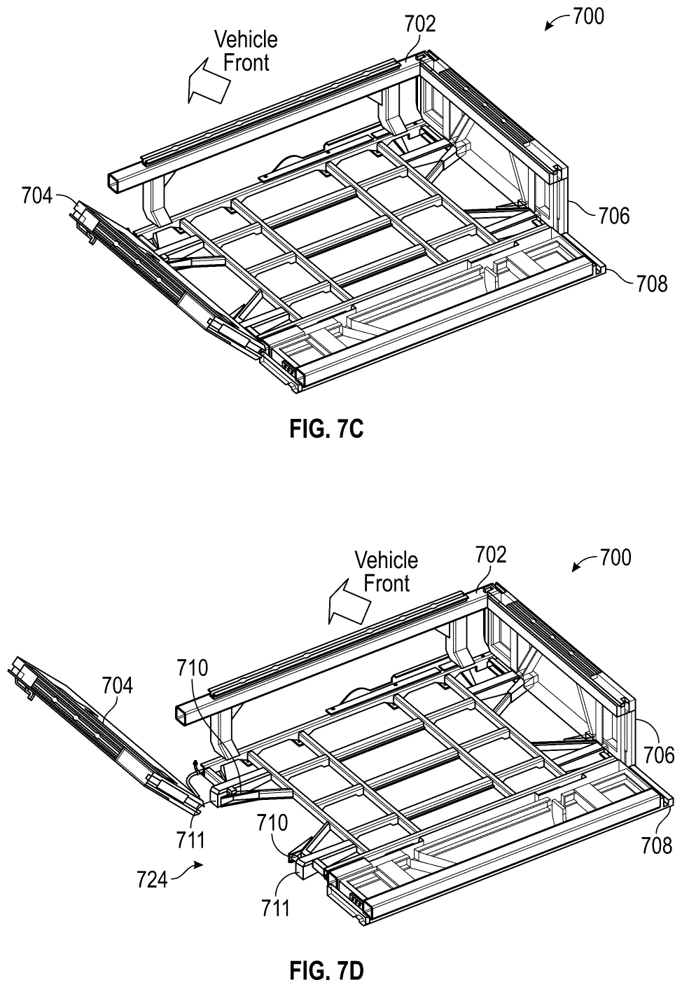

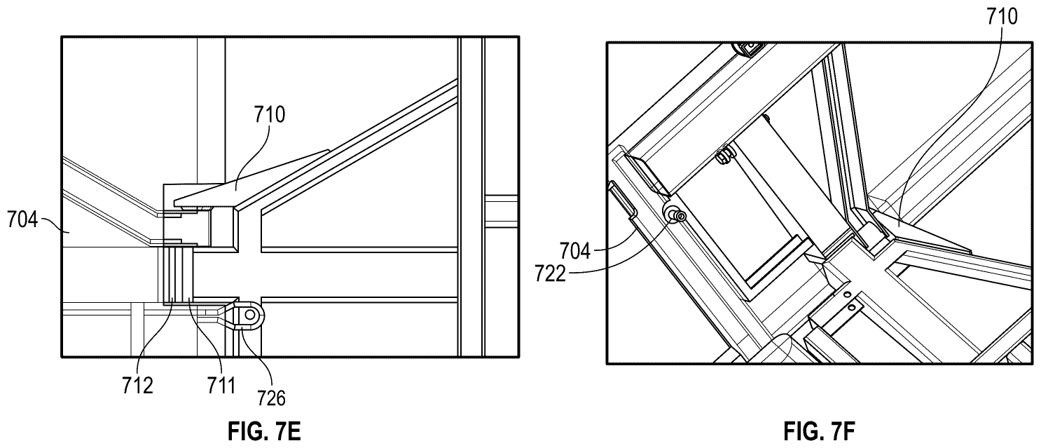

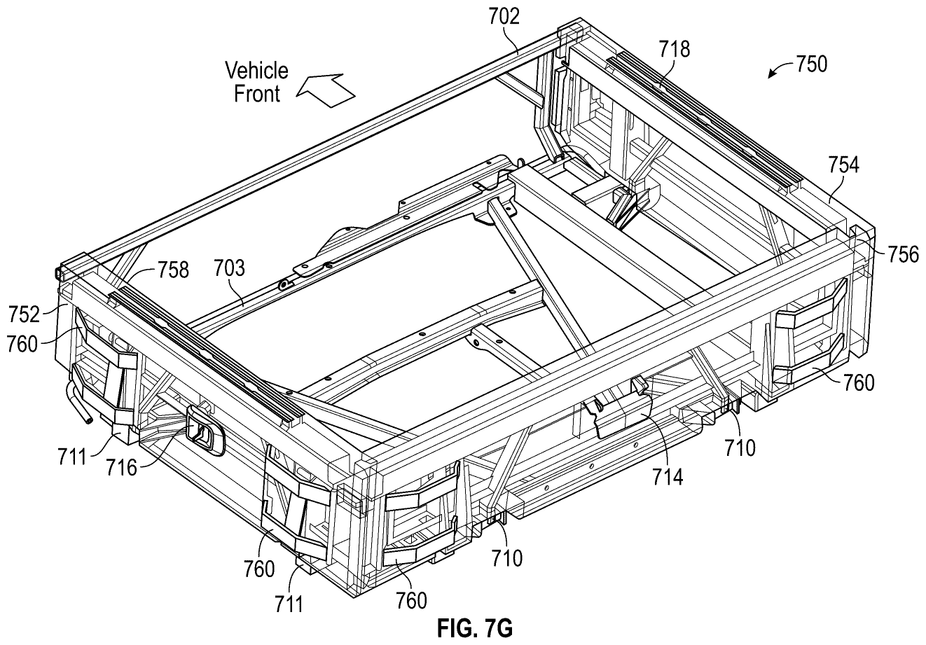

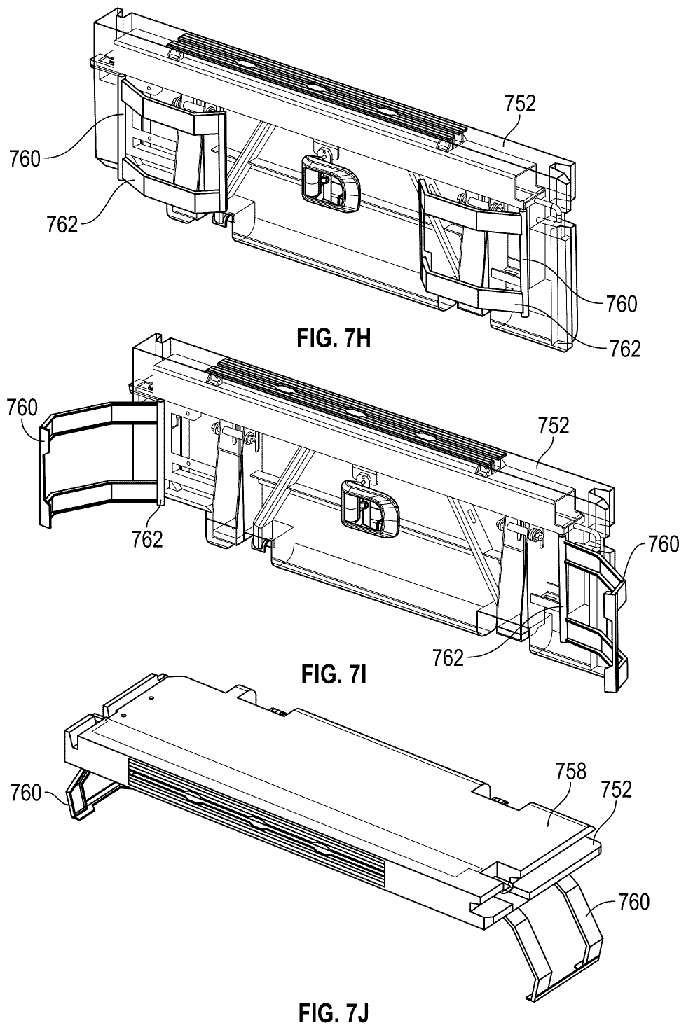

FIGS. 7A-7F illustrate example aspects of another cargo-carrying assembly 700, which may be a fold-flat cargo-carrying assembly, and which may be positioned on or otherwise form a rear portion of a vehicle (e.g., vehicle 100 in FIGS. 1A-1F). For instance, cargo-carrying assembly 700 may be used on top of or in place of bed 150 of vehicle 100.

With reference to FIGS. 7A-7D, cargo-carrying assembly 700 includes front member 702, side panels 704 and 706, and tailgate panel 708. Aspects of cargo-carrying assembly 700 are similar to those discussed above with respect to cargo-carrying assembly 400 in FIGS. 4A-4H and are therefore not redescribed in detail. For example, similar to cargo-carrying assembly 400, cargo-carrying assembly 700 includes removable panels 704, 706, and 708, which are further configurable according to a horizontal orientation (e.g., FIG. 7B where panels 704 and 708 are in a horizontal orientation) or a vertical orientation (as illustrated in FIG. 7A). Thus, cargo-carrying assembly 700 is capable of carrying objects having one or more dimensions that exceed that of cargo-carrying surface 703, as nothing substantially protrudes from the plane formed by cargo-carrying surface 703, panel 704, panel 706, and/or panel 708, as may otherwise be the case if posts or other support members were used in one or more corners of cargo-carrying surface 703. While cargo-carrying surface 703 is depicted as a frame for illustrative purposes, it will be appreciated that a panel or other covering may be supported by the frame to provide a surface on which to place objects. Further, panels 704, 706, and 708 are illustrated as being translucent to show an example support structure disposed therein.

Cargo-carrying assembly 700 is provided as an example where pins and support members need not be used (e.g., as compared to pins 418 and support members 412 discussed above with respect to cargo-carrying assembly 400). Rather, panels 704 and 706 are secured to front member 702 by latches 716. Additionally, tailgate panel 708 includes handle 714 which actuates latches 720 (FIG. 7B) to release tailgate panel 708, thereby allowing tailgate panel 708 to rotate from a vertical orientation to a horizontal orientation (FIG. 7B). Latches 720 interface with pins 722 of panels 704 and 706, thereby securing panel 704 and panel 706 to tailgate panel 708 when in a vertical orientation. It will be appreciated that any of a variety of additional or alternative mechanisms may be used to secure side panels 704 and 706 to tailgate panel 708, such as retractable pins that extend from tailgate panel 708 into corresponding slots of side panels 704 and 706.

Thus, to lay panels 704, 706, and 708 flat (or, as another example, to remove one or more panels), an individual actuates handle 714 to disengage latches 720 from pins 722, such that tailgate panel 708 can be placed in a horizontal orientation or removed. The individual may further actuate latches 716 to unsecure panel 704 and/or panel 706 from front member 702, thereby further permitting panel 704 and/or 706 to be placed in a horizontal orientation or removed.

To support panels 704, 706, and 708 in a horizontal orientation, rubber caps 712 are provided that interface with corresponding bump stops 711, thereby preventing over-rotation of the panels. Further, rubber caps 712 are used to avoid metal-on-metal contact that may result in premature wear among other detriments.

Further, panels 704, 706, and 708 rotate around hinges 710. Aspects of hinges 710 are similar to those discussed above with respect to hinges 410 discussed above with respect to cargo-carrying assembly 400 and are therefore not redescribed in detail. For example, hinges 710 may interface with a portion of panels 704, 706, and 708 having a similar profile to opening 413 (FIG. 4J), thereby permitting the panel to be separated from the hinge at approximately a 45-degree angle (as compared to a horizontal, or 0-degree, configuration for the panel; e.g., FIGS. 7C and 7D), though it will be appreciated that any of a variety of other angles may be used in other examples (e.g., a 30-degree angle or a 60-degree angle).

Cargo-carrying assembly 700 is provided as an example where two hinges are provided for each panel, though it will be appreciated that any number of hinges may be used in other examples. In the instant example, side panels 704 and 706 are supported by two hinges so as to provide regions 724 which may each receive a ground-engaging member of the vehicle. Additionally, or alternatively, side panels 704 and 706 may each be sized and shaped to similarly include a region corresponding to a ground-engaging member of the vehicle, thereby preventing interaction between the ground-engaging member and the panel during vehicle operation.

Panels 702, 704, 706, and 708 each include rails 718, which may be used to secure one or more objects within cargo-carrying assembly 700. It will be appreciated that rails 718 are provided as an example and any of a variety of additional or alternative features may be included in other examples. For example, one or more openings may be included that are each configured to receive an expansion retainer or other fastener.

In some examples, one or more cables 726 (FIG. 7E) are included to increase the structural rigidity of cargo-carrying assembly 700 and/or to lessen the load on bump stops 711 when a panel is in a horizontal orientation. For example, cable 726 is bolted or otherwise removably coupled to panel 704, thereby anchoring panel 704 to the frame of cargo-carrying surface 703. In other examples, cable 726 is omitted or, as another example, cable 726 is anchored only in a horizontal orientation so as to restrict rotation of the panel in the horizontal orientation. In examples, cables 726 reduce the load on bump stops 711, such that bump stops 711 may be thinner, thereby reducing the weight associated therewith.

It will be appreciated that the design of panels 704, 706, and 708 is provided for illustrative purposes and, in other examples, such aspects may further be combined with other aspects described herein. For example, panels 704, 706, and 708 (and, in examples, front member 702) may each include one or more protrusions and/or channels that are configured to permit nesting according to aspects described herein (e.g., channels 616 and protrusions 618 discussed above with respect to nesting panel assembly 600). Additionally, or alternatively, a storage rack similar to storage rack 500 may be used to store panels 704, 706, and 708 in some examples.

### Removable Side Panels/Portable Workbench.

With reference now to FIGS. 7G-7J, another example fold-flat cargo-carrying assembly 750 is illustrated. Aspects of fold-flat cargo-carrying assembly 750 are similar to those discussed above with respect to fold-flat cargo-carrying assembly 700 and are therefore not redescribed in detail.

As compared to the above-described panels of fold-flat cargo-carrying assembly 700, panels 752, 754, and 756 each include support members 760. As illustrated in FIGS. 7H-7J and referring to panel 752 as an example, each support member 760 is rotatably coupled to panel 752 using a respective hinge 762. As illustrated in FIG. 7H, support members 760 are in a closed configuration, such that they are secured or otherwise stored within panel 752. As an example, hinge 762 is a friction hinge, thereby restricting rotation of the support member, absent interaction by an individual. Additionally, or alternatively, one or more detents are used to manage rotation of support members 760, for example in a closed configuration and in an open configuration (FIG. 7I). It will be appreciated that, while example support member geometries (e.g., H-frames) are illustrated and associated coupling mechanisms are described, any of a variety of additional or alternative support members and/or corresponding coupling mechanisms may be used in other examples.

As illustrated in FIG. 7I, support members 760 are rotated outward (e.g., thereby achieving an open configuration for panel 752). FIG. 7J illustrates an example where panel 752 has been rotated and placed on a surface, such that support members 760 elevate panel 752 above the surface, thereby enabling the use of work surface 758 of panel 752. Given work surface 758 is toward the interior of the cargo-carrying assembly (FIG. 7G) when coupled to hinges 710 in a vertical orientation, work surface 758 may remain cleaner than the opposing side of panel 752. Even so, it will be appreciated that, in other examples, support members 760 may instead be located toward the interior of the cargo-carrying assembly, such that work surface 758 is instead the exterior surface of panel 752.

In examples, panels 752, 754, and/or 756 are placed adjacent to one another, such that multiple panels are used to form a combined work surface. Thus, the support members 760 of each respective panel may elevate the panel to a substantially similar height. In other examples, the panels need not be elevated to similar heights, for example as may be the case when panel 756 is used as a table and panels 752 and 754 are used as benches. As a further example, support members 760 has multiple positions, such that a panel is selectably elevated to one of multiple available heights in an open configuration.

### False Floor.

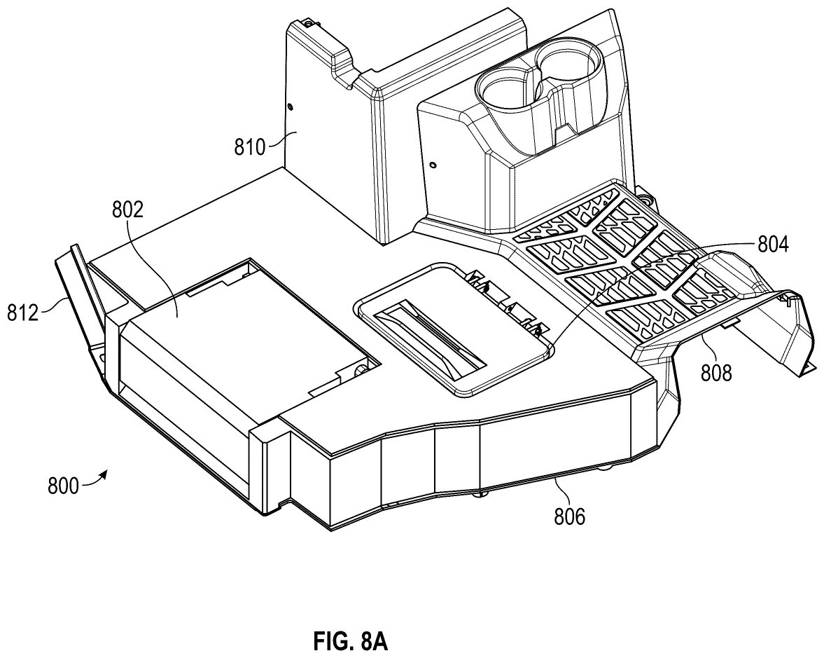

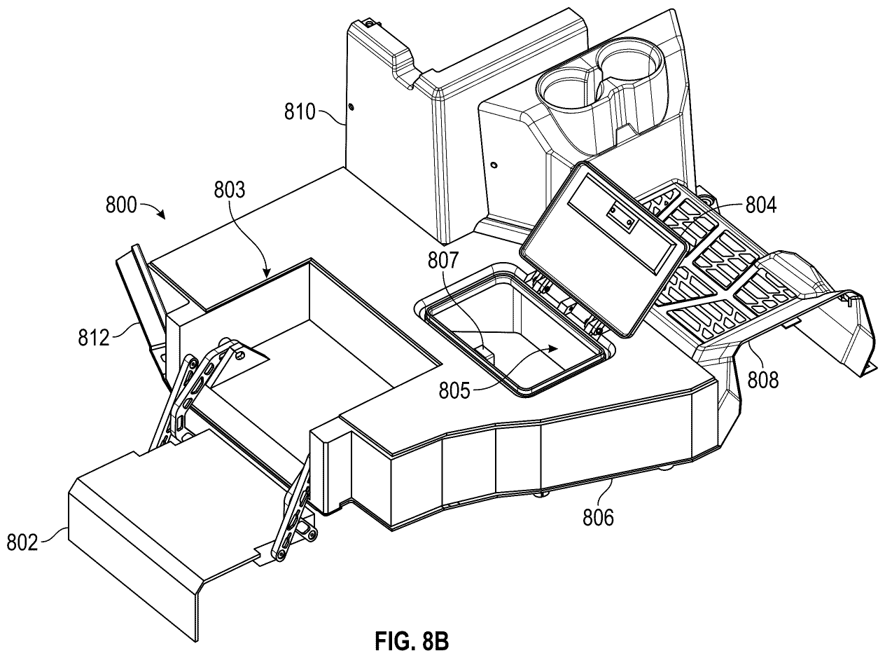

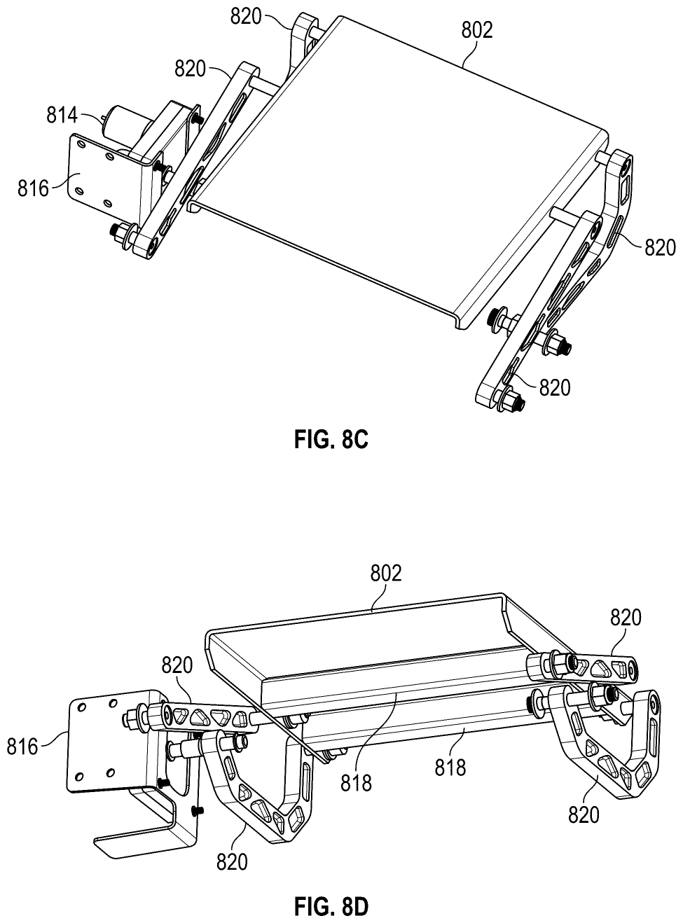

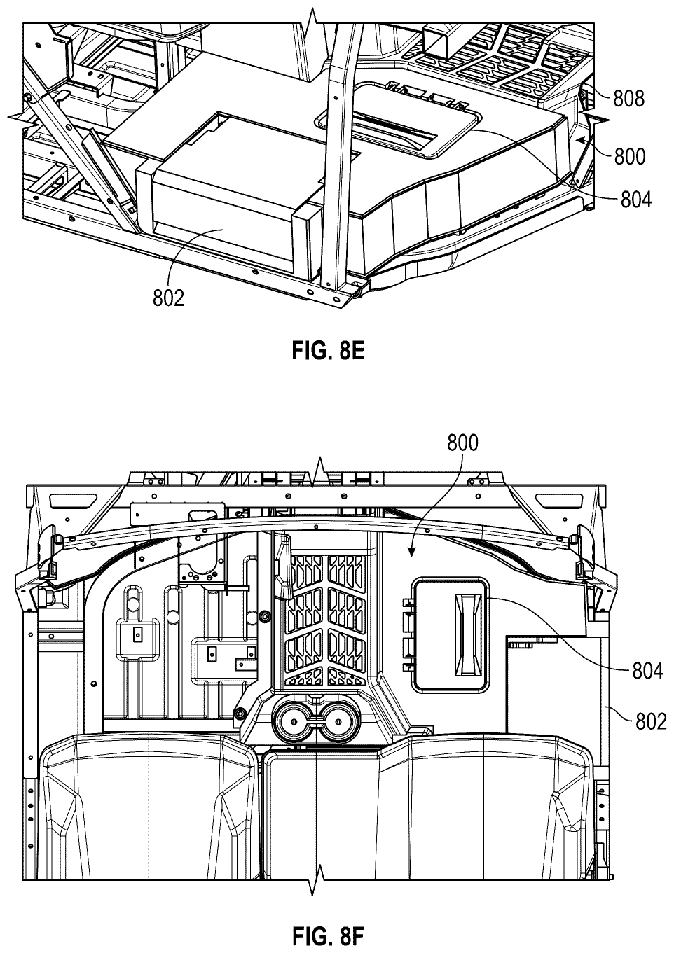

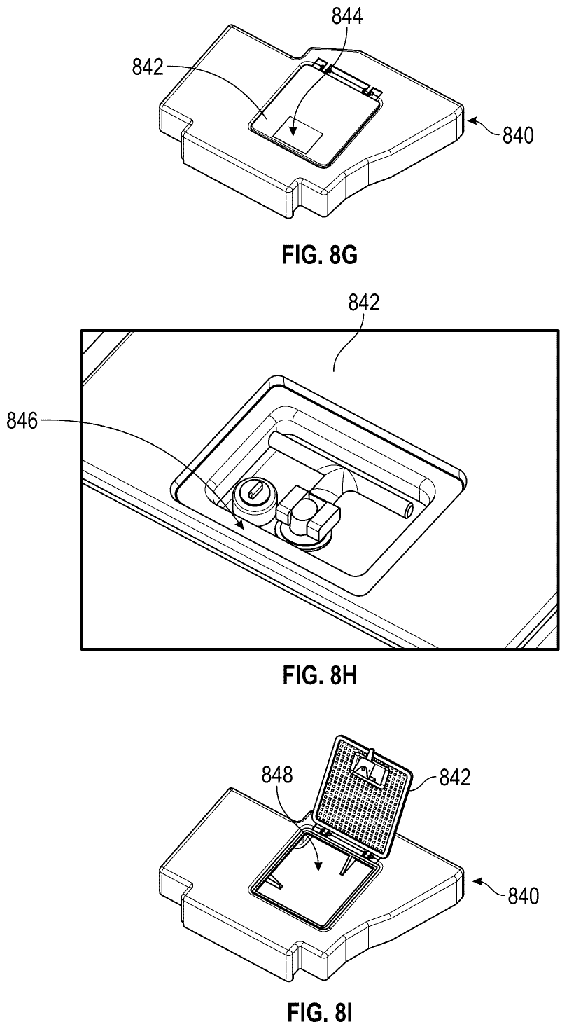

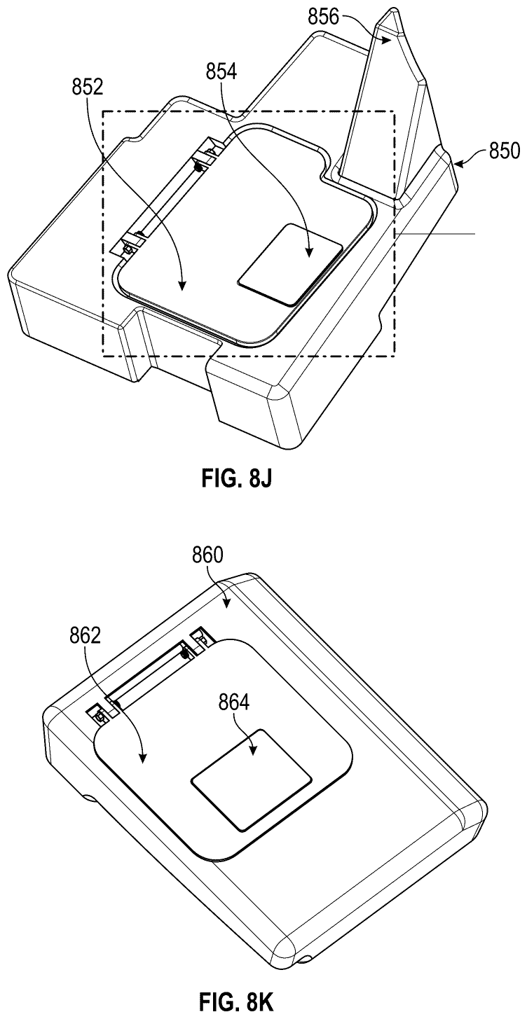

FIGS. 8A-8K illustrate example aspects relating to various false floor assemblies 800, 840, 850, and 860 for a vehicle (e.g., vehicle 100 in FIGS. 1A-1F). A false floor assembly according to aspects described herein may be used in a front row of a vehicle or a second row of a vehicle, among other examples.

With reference to FIGS. 8A-8F, false floor assembly 800 is provided. As illustrated, false floor assembly 800 includes step 802 and storage compartment lid 804. False floor assembly 800 is sized and shaped to rest on vehicle floor 806 and to fit within a space formed by vehicle components 808, 810, and 812 (see also FIGS. 8E and 8F). False floor assembly 800 may be retained within the vehicle using gravity, a friction fit, and/or one or more fasteners. For example, a bottom of false floor assembly 800 may include one or more openings through which a corresponding fastener may pass, such that false floor assembly 800 is fastened to vehicle floor 806 accordingly. In examples, the fastener pattern of false floor assembly 800 corresponds to a fastener pattern of the vehicle. It will be appreciated that any of a variety of fasteners may be used (e.g., screws, nuts/bolts, and/or expansion retainers).

The height of false floor assembly 800 may be similar to that of central tunnel 808, thereby providing a substantially continuous surface (e.g., including central tunnel 808 of the vehicle and the top surface of false floor assembly 800). Thus, step 802 and/or the reduced distance between a vehicle seat and vehicle floor 806 may each serve to improve comfort for a shorter rider of a vehicle. For instance, an individual may be able to sit with their feet resting on false floor assembly 800. As another example, an animal may have increased space on which to rest, as may be formed by the top surface of false floor assembly 800 and, in some examples, at least a part of central tunnel 808.

Further, false floor assembly 800 includes storage compartment 805 that is accessible via compartment lid 804. Thus, false floor assembly 800 not only improves rider comfort but also increases the usable storage space. False floor assembly 800 is illustrated as an example where step 802 is provided, but it will be appreciated that, in other examples, a false floor assembly may omit step 802, such that at least a part of region 803 may instead be used to provide increased storage space. Examples of such aspects are illustrated with respect to false floor assembly 840, 850, or 860 in FIGS. 8G-8K. As illustrated, compartment lid 804 is secured by magnetic latch 807, but it will be appreciated that any of a variety of additional or alternative latching mechanisms may be used, including, but not limited to, a locking latch and/or a friction fit.

Turning to FIGS. 8C and 8D, detail views of the motor subassembly are provided. As illustrated, step 802 is supported by support members 818 and arms 820. One of arms 820 is mechanically coupled to motor 814, which is coupled to motor mount 816. When motor 814 is actuated, arms 820 rotate, thereby extending step 802 (FIG. 8B). The illustrated configuration of arms 820 causes step 802 to remain substantially flat during actuation and when extended, though it will be appreciated that any of a variety of other motor subassemblies and associated steps may be used in other examples. For example, step 802 may instead rotate out, such that a top surface of step 802 in a retracted configuration becomes a bottom surface of step 802 in an extended configuration.

In examples, step 802 is remote controlled and/or is controllable via a button in an operator area. False floor assembly 800 may thus include one or more connectors (e.g., for power from a vehicle power system and/or from control from a vehicle controller). As another example, step 802 may be manually operated.

Turning to FIGS. 8G-8I, another example false floor assembly 840 is provided. Aspects of false floor assembly 840 are similar to those discussed above with respect to false floor assembly 800 and are therefore not redescribed in detail. False floor assembly 840 is provided as an example that omits a step, thereby providing a larger storage compartment 848 (FIG. 8I). Similar to false floor assembly 800, false floor assembly 840 includes compartment lid 842. Compartment lid 842 further includes latch cover 844, under which lockable latch 846 (FIG. 8H) is provided. Thus, latch cover 844 may prevent dirt and debris from entering lockable latch 846, while lockable latch 846 may protect the contents of false floor assembly 840.

Turning to FIG. 8J, another example false floor assembly 850 is provided. Aspects of false floor assembly 850 are similar to those discussed above with respect to false floor assembly 800 and/or 840, and are therefore not redescribed in detail. False floor assembly 850 is provided as an example that includes foot rest 856. Similar to false floor assembly 840, false floor assembly 850 includes compartment lid 852 and latch cover 854 (which covers a lockable latch, not pictured). Further, the geometry of false floor assembly 850 is different than false floor assemblies 800 and 840, as may be used for a different vehicle or for a different row of the same vehicle as compared to false floor assemblies 800 and 840.

FIG. 8K illustrates another example false floor assembly 860, aspects of which are similar to those discussed above with respect to false floor assemblies 800, 840, and/or 850. As illustrated, false floor assembly 860 similarly includes compartment lid 862 and latch cover 864. The geometry of false floor assembly 860 is different than false floor assemblies 800, 840, and 860, as may be used for a different vehicle or for a different row of the same vehicle as compared to false floor assemblies 800, 840, and 860. For instance, in examples where false floor assembly 860 is used in a rear row of a vehicle, the height of false floor assembly 860 may similarly correspond to that of a central tunnel of the vehicle.

### Under-Seat Storage Tray.

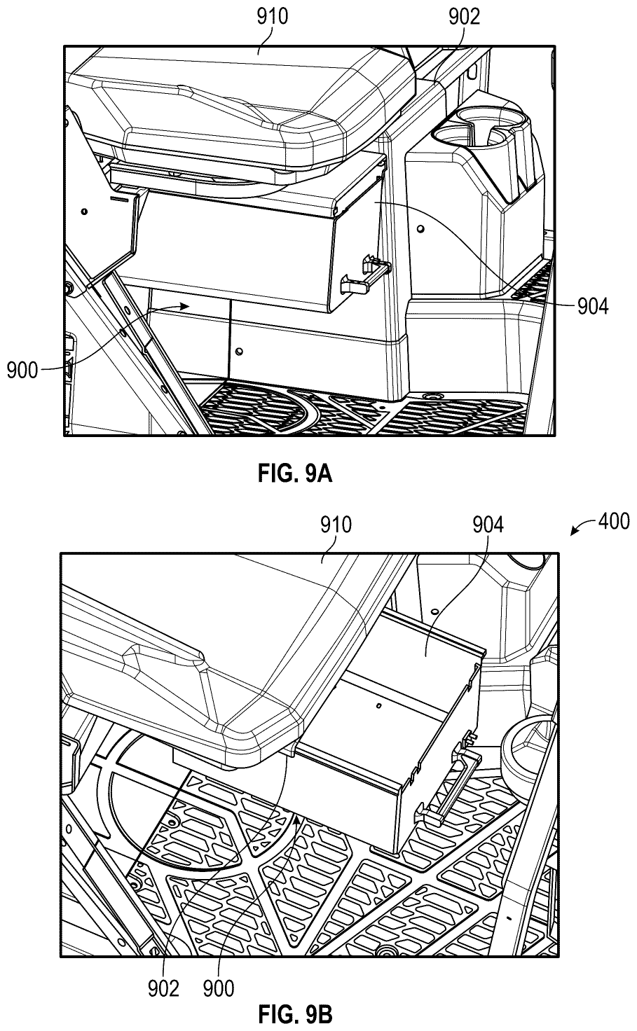

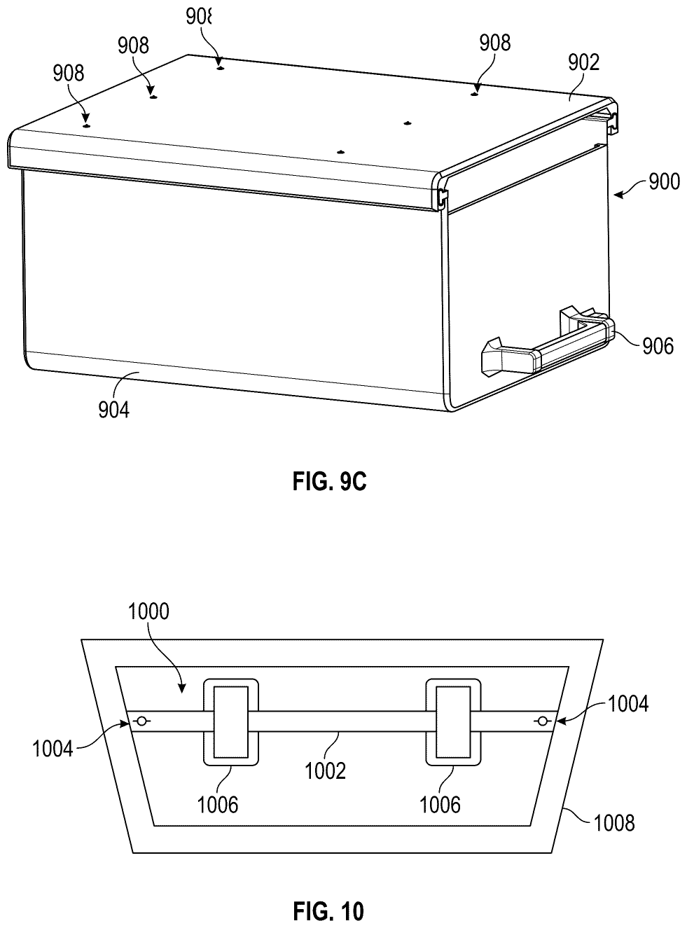

Turning to FIGS. 9A-9C, an example under-seat storage tray 900 is provided. As illustrated, under-seat storage tray 900 is coupled beneath seat 910 of a vehicle (e.g., vehicle 100 in FIGS. 1A-1F). While examples are illustrated with respect to a specific seat 910, it will be appreciated that similar aspects may be used to provide an under-seat storage tray for any of a variety of other seats and/or seating positions within a vehicle (e.g., a driver seat, a front passenger seat, and/or a rear passenger seat).

Under-seat storage tray 900 includes mounting lid 902 and drawer 904. In examples, drawer 904 is slidably disposed within mounting lid 902, such that an individual can slide drawer 904 out (e.g., toward the front of the vehicle) using handle 906 (FIG. 9C). Drawer 904 may be retained by mounting lid 902 using friction, such that drawer 904 does not move absent interaction by an individual. Additionally, or alternatively, mounting lid 902 includes one or more stops or detents that retain drawer 904 in a closed and/or open position, among other examples. Thus, under-seat storage tray 900 provides convenient access to any of a variety of objects that may be stored therein. In examples, under-seat storage tray 900 is sealed when closed to prevent dust/moisture ingress, among other examples.

With reference to FIG. 9C, mounting lid 902 includes openings 908 through which fasteners may be disposed, thereby securing under-seat storage tray 900 to seat 910. As another example, under-seat storage tray 900 may be clamped beneath seat 910. For example, mounting lid 902 may be mounted with drawer 904 removed, after which drawer 904 may be slidably inserted into mounting lid 902. While an example fastener pattern is illustrated, it will be appreciated that additional or fewer fasteners may be used according to any of a variety of other patterns in other examples. In some instances, the fastener pattern of mounting lid 902 corresponds to a pre-existing fastener pattern of the vehicle or, as another example, one or more new mounting holes may be formed (e.g., by an individual) with which to mount under-seat storage tray 900 accordingly.

In examples, under-seat storage tray 900 is sized and shaped to avoid interference with an individual sitting in seat 910 (e.g., the back of the individuals legs) and/or with operation of a glove box or other functionality of the vehicle, among other examples. Further, the depth of drawer 904 may be such that it can be fully or mostly extended when installed within the vehicle. As illustrated in FIGS. 9A and 9B, under-seat storage tray 900 maintains a clearance between drawer 904 and the vehicle floor, though it will be appreciated, in other examples, drawer 904 may extend to fill substantially all of the space between the underside of seat 910 and the vehicle floor.

### Tool Holder.

FIG. 10 illustrates a schematic view of an example storage system 1000 for retaining objects within a storage compartment 1008 of a vehicle (e.g., vehicle 100 in FIGS. 1A-1F) according to aspects described herein. As an example, storage compartment 1008 may be a front or a rear storage compartment of a vehicle. As another example, storage compartment 1008 may be formed by a portable work surface assembly, as was discussed above with respect to FIGS. 2A-2E or 3A-3D. Storage system 1000 thus promotes organization within storage compartment 1008.

As illustrated, storage system 1000 includes storage band 1002 and retention members 1004. As illustrated, storage band 1002 includes an opening at either end that each cooperate with a corresponding retention member 1004 to retain storage band 1002 within storage compartment 1008. Any number of retention members 1004 may be used in other examples. It will be appreciated that any of a variety of additional or alternative retention mechanisms may be used, including, but not limited to, a hook and loop fastener and/or a clasp. Further, while storage system 1000 is illustrated in a horizontal orientation, it will be appreciated that similar aspects may be used to retain storage band 1002 in a vertical orientation or in any of a variety of other orientations. Additionally, FIG. 10 illustrates an example in which one storage band 1002 is used, but any number of storage bands and corresponding retention members may be used in other examples.

Storage band 1002 may be comprised of a rubber or nylon material and may be sized and shaped similar to a belt. Thus, storage band 1002 may be used to retain a variety of objects (e.g., objects 1006) having a belt clip or other mounting mechanism intended to function with a belt. As a result of storage band 1002 conforming to such dimensions, an individual may be able to easily store objects using existing belt-interaction features and without acquiring specific mounting hardware. In some examples, storage system 1000 further includes one or more mounts that each have a belt-interaction feature with which to be mounted to storage band 1002, which may thus be used to retain objects that do not have existing belt-interaction features. In examples, storage band 1002 includes a clasp or other mechanism that joins a first portion of storage band 1002 to a second portion of storage band 1002, thereby permitting objects to be added or removed from the middle (or other intermediate location) of storage band 1002 (e.g., rather than needing to remove storage band 1002 from one or both retention features 1004).

### Seat-Integrated Document Holder.

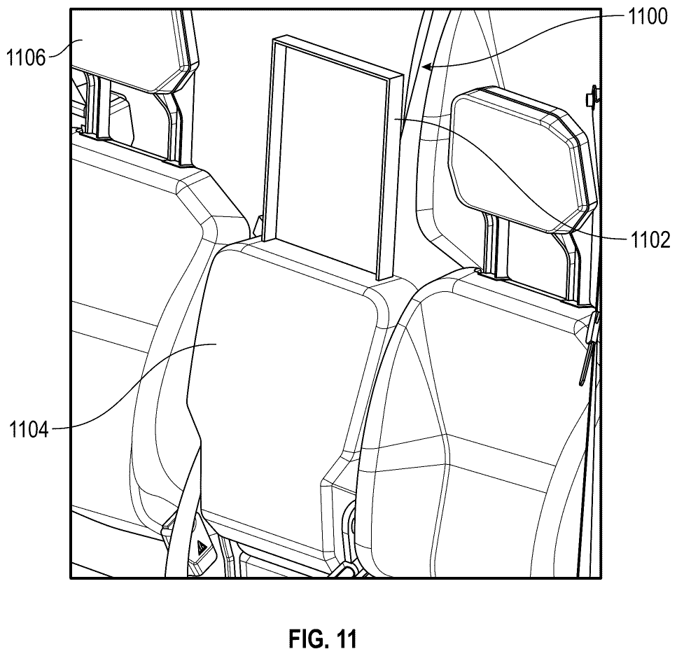

FIG. 11 illustrates an example in-seat storage assembly 1100 according to aspects described herein. As illustrated, in-seat storage assembly 1100 includes drawer 1102 and seat 1104 of a vehicle (e.g., vehicle 100 in FIGS. 1A-1F). While in-seat storage assembly 1100 is illustrated using a middle seat of the vehicle, it will be appreciated that similar techniques may be used for any of a variety of other seats. For instance, in-seat storage assembly 1100 may be longitudinally offset from a headrest (e.g., headrest 1106), such that drawer 1102 can be extended in front of or behind the headrest.

In examples, drawer 1102 is retained within seat 1104 using a push-button mechanism, such that an individual can actuate the push-button mechanism to open/close drawer 1102. In a closed configuration, drawer 1102 may be sealed to prevent dust/moisture ingress. Further, due to the location of drawer 1102 within seat 1104, documents or other objects placed within drawer 1102 may be safe from or otherwise have reduced exposure to damage, water that enters the vehicle, and/or inadvertent access by other individuals. In examples, drawer 1102 is sized and shaped to permit document storage without folding documents stored therein. In other examples, a locking latch is used to secure drawer 1102. As a further example, drawer 1102 may be automatically secured when the vehicle is not in operation, for example by disactivating a push-button mechanism or by retaining drawer 1102 within seat 1104 using an extendable pin, latch, or other mechanism.

### Dual-Action Access.

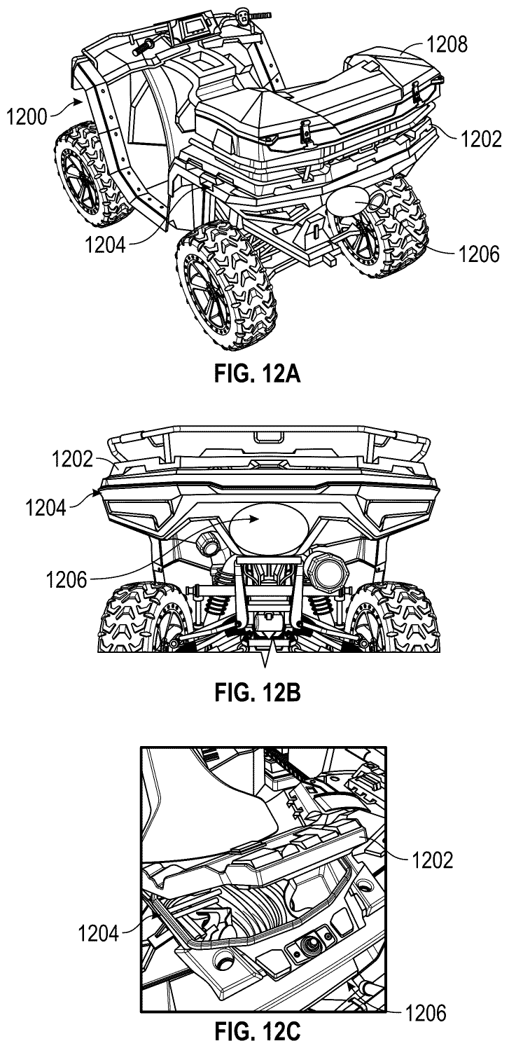

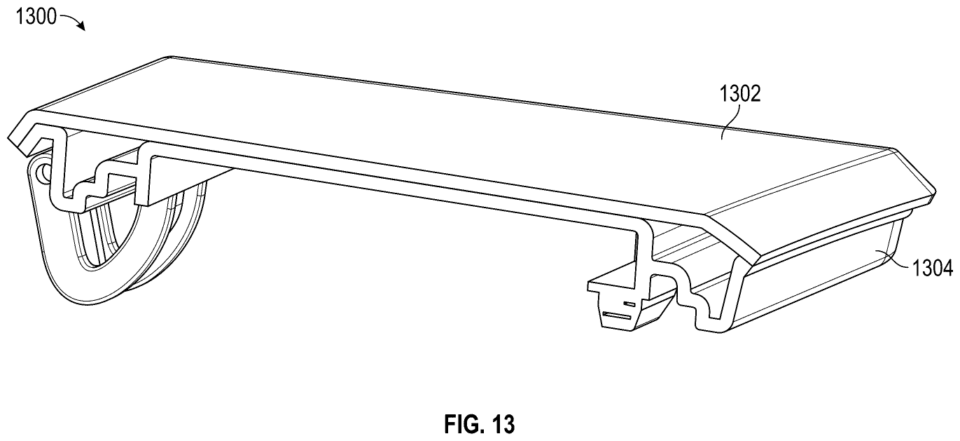

FIGS. 12A-12C illustrate an example vehicle 1200 having storage compartment 1204 that is accessible from multiple access points. Aspects of vehicle 1200 are similar to those discussed above (e.g., with reference to vehicle 100) and are therefore not redescribed in detail. As illustrated, storage compartment 1204 is located beneath lid 1202, such that an individual may access storage compartment 1204 by rotating upward or otherwise removing lid 1202 (e.g., thus providing a first access point for storage compartment 1204). An example of such aspects is illustrated in FIG. 12C.

However, as illustrated in FIG. 12A, one or more objects (e.g., storage box 1208, as illustrated) may be placed on top of lid 1202, thereby restricting access to storage compartment 1204. Accordingly, the disclosed aspects further include lid 1206 to provide a rear access point to storage compartment 1204. The illustrated example depicts lid 1206 as being centrally located at the rear of vehicle 1200, but it will be appreciated that the rear access point may be placed at another location along the rear or, as another example, a side of vehicle 1200. Further, multiple such access points may be used (e.g., an access point at a right rear and a left rear of vehicle 1200). Similarly, it will be appreciated that the depicted location of lid 1202 is provided for illustrative purposes and any of a variety of other locations and/or number of such lids may be used in other examples.

In examples, lid 1206 is formed from rubber or a hard plastic, such that a friction fit may be used to retain lid 1206. As another example, lid 1206 is hinged, such that an individual can rotate lid 1206 to access storage compartment 1204. In some examples, a latch or a locking latch is used to secure lid 1206 accordingly.

It will be appreciated that vehicle 1200 is provided as an example vehicle and that similar techniques may be used for a variety of other vehicles having similar storage compartments (e.g., at the back, front, or one or more sides of the vehicle).

### Two-Part Structural and Cosmetic Storage Box Lid System.

FIG. 13 illustrates a perspective view of an example two-part lid 1300 for a storage compartment of a vehicle (e.g., vehicle 100 in FIGS. 1A-1F) according to aspects described herein. As illustrated, two-part lid includes outer lid 1302 and inner lid 1304. Outer lid 1302 and inner lid 1304 may be mechanically and/or chemically joined to form two-part lid 1300. As an example, two-part lid 1300 is used for a storage compartment in an operator area of a vehicle, such as operator area 160 of vehicle 100 (FIG. 1A).

In examples, outer lid 1302 is provided to improve the cosmetic appearance of two-part lid 1300, for example to match a vehicle interior (e.g., a color and/or material choice therein). In examples, inner lid 1304 provides substantially all of the structural rigidity of two-part lid 1300. In another example, inner lid 1304 includes or otherwise provides latching, hinging, and/or sealing features. Additionally, or alternatively, outer lid 1302 prevents or reduces intrusion of high pressure water to a seal on inner lid 1304, such that the inner lid seal need only be rated for comparatively lower pressure water. Similarly, outer lid 1302 may prevent or reduce intrusion of larger debris, while inner lid 1304 prevents or reduces intrusion of smaller debris or dust. Thus, as compared to a lid formed from a single part, two-part lid 1300 provides improved cosmetic characteristics (offered by outer lid 1302) while also including the functional characteristics provided by inner lid 1304.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

The following Examples are provided as example aspects of the disclosed subject matter:

Example 1. A portable work surface assembly for a vehicle is provided. The portable work surface assembly comprising a plurality of panels that cooperate, in a closed configuration of the portable work surface assembly, to form a storage cavity. The plurality of panels comprising a bottom panel, a plurality of side panels coupled to the bottom panel, a front panel coupled to the bottom panel, a top panel hingedly coupled to the front panel, and a rear panel coupled to the bottom panel, wherein the top panel is removably coupled to the rear panel. The portable work surface assembly also comprising a plurality of support members coupled to the top panel of the portable work surface assembly, wherein the plurality of support members are configured to, in an open configuration of the portable work surface assembly, support the top panel, and a mount coupled to the at least one panel of the plurality of panels, wherein the mount is configured to removably attach the portable work surface assembly to the vehicle.

Example 2. The portable work surface assembly of Example 1, wherein the front panel is hingedly coupled to the bottom panel and the mount is coupled to the bottom panel.

Example 3. The portable work surface assembly of Example 1, wherein the front panel is coupled to the bottom panel via an intermediate panel, the front panel is hingedly coupled to the intermediate panel, the intermediate panel is hingedly coupled to the bottom panel, and the mount comprises two parts that are each coupled to a side panel of the plurality of side panels.

Example 4. The portable work surface assembly of Example 3, wherein the mount, when coupled to the vehicle, is configured form a gap between the bed of the vehicle and the bottom panel, and the intermediate panel is sized according to the gap between the bed of the vehicle and the bottom panel, thereby enabling the front panel to rest on the vehicle in the open configuration.

Example 5. The portable work surface assembly of Example 1, wherein the top panel is removably coupled to the rear panel using a plurality of latches.

Example 6. The portable work surface assembly of Example 1, wherein the plurality of support members comprise a first support member disposed at a first end of the top panel and a second support member disposed at a second end of the top panel, and the plurality of support members rotate outward from the top panel to support the top panel in the open configuration.

Example 7. The portable work surface assembly of Example 6, wherein each support member of the plurality of support members is telescopic, thereby permitting a user to adjust a length of the support member.

Example 8. The portable work surface assembly of Example 1, wherein the bottom panel, the front panel, and the top panel, in the open configuration, cooperate to form a work surface.

Example 9. The portable work surface assembly of Example 1, wherein the bottom panel and the plurality of side panels are formed as a single piece.

Example 10. The portable work surface assembly of Example 1, wherein the mount is removably coupled to the bottom panel of the portable work surface assembly and the mount is selected from a plurality of mounts, wherein each mount of the plurality of mounts corresponds to a different vehicle, thereby enabling the portable work surface assembly to be adapted for a given vehicle by selecting a corresponding mount from the plurality of mounts.

Example 11. The portable work surface assembly of Example 1, wherein the portable work surface assembly is sized according to a size of a plurality of sizes, wherein each size of the plurality of sizes corresponds to a different vehicle type.

Example 12. A cargo-carrying assembly for a vehicle is provided. The cargo-carrying assembly comprising a cargo-carrying surface supported by a frame of the cargo-carrying assembly, a plurality of panels that are each removably coupled to the frame by a respective hinge of a plurality of hinges, the plurality of panels comprising a first side panel, a second side panel, and a tailgate panel, wherein each panel of the plurality of panels includes an opening configured to receive a hinge of the plurality of hinges, each hinge of the plurality of hinges is sized and shaped to permit rotation of a panel around an axis and to permit removal of the panel at a predefined angle, in a vertical orientation, the tailgate panel is configured to be removably coupled to the first side panel in a vertical orientation and the second a vertical orientation, and in horizontal orientations, the tailgate panel, the first side panel, and the second side panel cooperate with the cargo-carrying surface to form a work surface.

Example 13. The cargo-carrying assembly of Example 12, wherein the first side panel and the second side panel, in vertical orientations, are each configured to be removably coupled to a front panel of the vehicle.

Example 14. The cargo-carrying assembly of Example 12, further comprising a plurality of support members supported by the frame that each correspond to a panel of the plurality of panels wherein each support member removably couples to a panel, in a horizontal orientation at a first opening of the panel, in a vertical orientation at a second opening of the panel.

Example 15. The cargo-carrying assembly of Example 14, wherein each support member is rotatably coupled to a bracket of the frame and further comprises a bump stop to inhibit over-rotation of the support member.

Example 16. The cargo-carrying assembly of Example 15, wherein each support member is removably coupled to the frame.

Example 17. The cargo-carrying assembly of Example 14, wherein each panel of the plurality of panels has an associated hinge having a first axis of rotation and an associated support member having a second axis of rotation, and when the associated support member is coupled to the panel in the horizontal orientation via the first opening of the panel, the first axis of rotation of the associated hinge and the second axis of rotation of the associated support member thus substantially lock the panel in the horizontal orientation.

Example 18. The cargo-carrying assembly of Example 12, wherein the first side panel and the second side panel are each removably coupled to the tailgate by a latch of a plurality of latches, and the tailgate panel further comprises a handle configured to actuate the plurality of latches, thereby decoupling the tailgate from the first side panel and the second side panel.

Example 19. The cargo-carrying assembly of Example 18, wherein each panel includes a bump stop configured to interface with the frame in a horizontal orientation, thereby preventing over-rotation of the panel in the horizontal orientation.

Example 20. The cargo-carrying assembly of Example 18, wherein each panel is removably coupled to the frame using two hinges of the plurality of hinges.

Example 21. The cargo-carrying assembly of Example 12, further comprising a storage rack for the plurality of panels, the storage rack configured to be removably coupled to a front panel of the vehicle.

Example 22. The cargo-carrying assembly of Example 12, wherein a first panel of the plurality of panels comprises a channel that is configured to receive a protrusion of a second panel of the plurality of panels.

Example 23. The cargo-carrying assembly of Example 22, wherein the first panel further comprises an opening configured to receive a fastener to fasten the first panel to another panel of the plurality of panels.

Example 24. A false floor assembly for a vehicle is provided. the false floor assembly comprising an enclosure forming a storage compartment, wherein a height of the enclosure corresponds to a height of a central tunnel of the vehicle and a bottom of the enclosure includes a plurality of openings that are each configured to receive a fastener therethrough, thereby securing the enclosure to the vehicle, a storage compartment lid disposed in a top surface of the enclosure, wherein the storage compartment lid includes a lockable latch and is rotatably coupled to the enclosure by a hinge, and a step assembly mechanically coupled to the enclosure, wherein the step assembly, when actuated, extends a step to support a passenger of the vehicle.

Example 25. An under-seat storage assembly for a vehicle is provided. The under-seat storage assembly comprising a lid configured to be coupled to an underside of a seat of the vehicle using a fastener pattern corresponding to one or more pre-existing openings in the underside of the seat, the lid comprising a plurality of tracks, and a drawer configured to be supported by the plurality of tracks of the lid, wherein the tracks comprise a first detent that corresponds to an open position of the drawer and a second detent that corresponds to a closed position of the drawer.

Example 26. A vehicle is provided. The vehicle comprising a plurality of ground-engaging members, a frame supported by the plurality of ground-engaging members, and a rear storage compartment supported by the frame. The rear storage compartment having a first access point at a top of the rear storage compartment and a second access point at a rear of the rear storage compartment.

Example 27. The vehicle of Example 26, wherein the vehicle further comprises a seat supported by the frame and the seat comprises a drawer disposed within the seat that is configured to move in a substantially vertical direction, the drawer is longitudinally offset from a headset of the seat, and the drawer includes a push-button mechanism that, when actuated, allows the drawer to be moved out of the seat in the substantially vertical direction.

Example 28. The vehicle of Example 26, wherein the rear storage compartment further comprises a plurality of retention members disposed within the rear storage compartment and a storage band removably coupled to the retention members, wherein the storage band is sized and shaped to retain one or more objects that each have a belt-interaction feature.

Example 29. The vehicle of Example 26, wherein the vehicle further comprises a two-part lid. The two-part lid comprising an outer lid, wherein the outer lid matches a cosmetic appearance of an interior of the vehicle and an inner lid coupled to the outer lid, wherein the inner lid provides substantially all of the rigidity of the two-part lid and further provides at least one of a latching feature, a hinging feature, or a sealing feature.

Example 30. The vehicle of Example 29, wherein the outer lid is rated for at least one of higher water resistance or debris resistance as compared to the inner lid.

1. A portable work surface assembly for a vehicle, the portable work surface assembly comprising:
a plurality of panels that cooperate, in a closed configuration of the portable work surface assembly, to form a storage cavity, the plurality of panels comprising:
a bottom panel;
a plurality of side panels coupled to the bottom panel;
a front panel coupled to the bottom panel;
a top panel hingedly coupled to the front panel; and
a rear panel coupled to the bottom panel, wherein the top panel is removably coupled to the rear panel;
a plurality of support members coupled to the top panel of the portable work surface assembly, wherein the plurality of support members are configured to, in an open configuration of the portable work surface assembly, support the top panel; and
a mount coupled to the at least one panel of the plurality of panels, wherein the mount is configured to removably attach the portable work surface assembly to the vehicle.

2. The portable work surface assembly of claim 1, wherein:
the front panel is hingedly coupled to the bottom panel; and
the mount is coupled to the bottom panel.

3. The portable work surface assembly of claim 1, wherein:
the front panel is coupled to the bottom panel via an intermediate panel;
the front panel is hingedly coupled to the intermediate panel;
the intermediate panel is hingedly coupled to the bottom panel; and
the mount comprises two parts that are each coupled to a side panel of the plurality of side panels.

4. The portable work surface assembly of claim 3, wherein:
the mount, when coupled to the vehicle, is configured form a gap between the bed of the vehicle and the bottom panel; and
the intermediate panel is sized according to the gap between the bed of the vehicle and the bottom panel, thereby enabling the front panel to rest on the vehicle in the open configuration.

5. The portable work surface assembly of claim 1, wherein the top panel is removably coupled to the rear panel using a plurality of latches.

6. The portable work surface assembly of claim 1, wherein:
the plurality of support members comprise:
a first support member disposed at a first end of the top panel; and
a second support member disposed at a second end of the top panel; and
the plurality of support members rotate outward from the top panel to support the top panel in the open configuration.

7. The portable work surface assembly of claim 6, wherein each support member of the plurality of support members is telescopic, thereby permitting a user to adjust a length of the support member.

8. The portable work surface assembly of claim 1, wherein the bottom panel, the front panel, and the top panel, in the open configuration, cooperate to form a work surface.

9. The portable work surface assembly of claim 1, wherein the bottom panel and the plurality of side panels are formed as a single piece.

10. The portable work surface assembly of claim 1, wherein:
the mount is removably coupled to the bottom panel of the portable work surface assembly; and
the mount is selected from a plurality of mounts, wherein each mount of the plurality of mounts corresponds to a different vehicle, thereby enabling the portable work surface assembly to be adapted for a given vehicle by selecting a corresponding mount from the plurality of mounts.

11. The portable work surface assembly of claim 1, wherein the portable work surface assembly is sized according to a size of a plurality of sizes, wherein each size of the plurality of sizes corresponds to a different vehicle type.

12. A cargo-carrying assembly for a vehicle, the cargo-carrying assembly comprising:
a cargo-carrying surface supported by a frame of the cargo-carrying assembly;
a plurality of panels that are each removably coupled to the frame by a respective hinge of a plurality of hinges, the plurality of panels comprising a first side panel, a second side panel, and a tailgate panel, wherein:
each panel of the plurality of panels includes an opening configured to receive a hinge of the plurality of hinges;
each hinge of the plurality of hinges is sized and shaped to permit rotation of a panel around an axis and to permit removal of the panel at a predefined angle;
in a vertical orientation, the tailgate panel is configured to be removably coupled to the first side panel in a vertical orientation and the second a vertical orientation; and
in horizontal orientations, the tailgate panel, the first side panel, and the second side panel cooperate with the cargo-carrying surface to form a work surface.

13. The cargo-carrying assembly of claim 12, wherein the first side panel and the second side panel, in vertical orientations, are each configured to be removably coupled to a front panel of the vehicle.

14. The cargo-carrying assembly of claim 12, further comprising a plurality of support members supported by the frame that each correspond to a panel of the plurality of panels, wherein:
each support member removably couples to a panel:
in a horizontal orientation at a first opening of the panel; and
in a vertical orientation at a second opening of the panel.

15.-17. (canceled)

18. The cargo-carrying assembly of claim 12, wherein:
the first side panel and the second side panel are each removably coupled to the tailgate by a latch of a plurality of latches; and
the tailgate panel further comprises a handle configured to actuate the plurality of latches, thereby decoupling the tailgate from the first side panel and the second side panel.

19.-20. (canceled)

21. The cargo-carrying assembly of claim 12, further comprising a storage rack for the plurality of panels, the storage rack configured to be removably coupled to a front panel of the vehicle.

22. The cargo-carrying assembly of claim 12, wherein a first panel of the plurality of panels comprises a channel that is configured to receive a protrusion of a second panel of the plurality of panels.

23. (canceled)

24. A false floor assembly for a vehicle, the false floor assembly comprising:
an enclosure forming a storage compartment, wherein a height of the enclosure corresponds to a height of a central tunnel of the vehicle and a bottom of the enclosure includes a plurality of openings that are each configured to receive a fastener therethrough, thereby securing the enclosure to the vehicle;
a storage compartment lid disposed in a top surface of the enclosure, wherein the storage compartment lid includes a lockable latch and is rotatably coupled to the enclosure by a hinge; and
a step assembly mechanically coupled to the enclosure, wherein the step assembly, when actuated, extends a step to support a passenger of the vehicle.

25. An under-seat storage assembly for a vehicle, the under-seat storage assembly comprising:
a lid configured to be coupled to an underside of a seat of the vehicle using a fastener pattern corresponding to one or more pre-existing openings in the underside of the seat, the lid comprising a plurality of tracks; and
a drawer configured to be supported by the plurality of tracks of the lid, wherein the tracks comprise a first detent that corresponds to an open position of the drawer and a second detent that corresponds to a closed position of the drawer.

26. A vehicle, comprising:
a plurality of ground-engaging members;
a frame supported by the plurality of ground-engaging members; and
a rear storage compartment supported by the frame, the rear storage compartment having:
a first access point at a top of the rear storage compartment; and
a second access point at a rear of the rear storage compartment.

27.-30. (canceled)
